(19) United States
(12) Patent Application Publication
(10) Pub. No.: US 2025/0303771 A1
(43) Pub. Date: Oct. 2, 2025

(54) Recording Method And Recording Apparatus

(71) Applicant: SEIKO EPSON CORPORATION, Tokyo (JP)

(72) Inventors: Naoki KOIKE, Matsumoto (JP); Mitsuaki KOSAKA, Minowa (JP)

(21) Appl. No.: 19/090,950

(22) Filed: Mar. 26, 2025

(30) Foreign Application Priority Data
Mar. 27, 2024 (JP) 2024-051073

(51) Int. Cl. B41M 5/00; B41J 2/21; B41J 11/00; B41M 7/00; C09D 11/38; C09D 11/54

(52) U.S. Cl. CPC B41M 5/0017; B41J 2/2117; B41J 11/0022; B41J 11/0024; B41M 7/009; C09D 11/38; C09D 11/54

(57) ABSTRACT

A recording method includes attaching a processing liquid containing an aggregating agent to a recording medium; ejecting and attaching an ink composition from an ink jet head to the recording medium; transporting the recording medium after the attaching the processing liquid and the attaching the ink composition to a heating mechanism; and heating the transported recording medium at the heating mechanism, wherein the ink composition is an aqueous ink composition containing a coloring material, the ink composition is attached to the recording medium while the recording medium is supported by a recording medium support, the recording medium support is free of a device that conductively heats the recording medium supported by the recording medium support, the heating mechanism has a portion positioned in a space extending from an area of the recording medium supported by the recording medium support where the ink composition is attachable toward an opposite side from the ink jet head in a vertical direction, and the recording medium supported by the recording medium support and to which the ink composition is attached has a surface temperature of 27° C. or higher and 38° C. or lower.

The present application is based on, and claims priority from JP Application Serial Number 2024-051073, filed Mar. 27, 2024, the disclosure of which is hereby incorporated by reference herein in its entirety.

### BACKGROUND

### 1. Technical Field

The present disclosure relates to a recording method and a recording apparatus.

### 2. Related Art

There is a known ink jet recording method that records an image on a recording medium by ejecting minute ink droplets from a nozzle of an ink jet head of an ink jet recording apparatus. For example, the ink jet recording method has been studied for use in sign printing, label printing, packaging printing, and the like.

JP-A-2011-056832 discloses a printer including a drying step. The printer described in the above document performs primary drying for drying ink attached to a recording medium and secondary drying after the primary drying. The secondary drying is performed at a high heating temperature on a downstream side in a transport direction after the recording medium is transported. In contrast, in the printer described in the above document, the primary drying is performed near a platen.

However, when the recording medium is heated, the nozzle of the recording head may be clogged. However, when the recording medium is not heated, it is difficult to dry the ink at an early stage, and the image quality may be insufficient. In addition, when heating the recording medium is required, it is not possible to simplify the recording apparatus or to save space.

### SUMMARY

A recording method according to an aspect of the present disclosure includes attaching a processing liquid containing an aggregating agent to a recording medium; ejecting and attaching an ink composition from an ink jet head to the recording medium; transporting the recording medium after the attaching the processing liquid and the attaching the ink composition to a heating mechanism; and heating the transported recording medium at the heating mechanism, wherein the ink composition is an aqueous ink composition containing a coloring material, the ink composition is attached to the recording medium while the recording medium is supported by a recording medium support, the recording medium support is free of a device that conductively heats the recording medium supported by the recording medium support, the heating mechanism has a portion positioned in a space extending from an area of the recording medium supported by the recording medium support where the ink composition is attachable toward an opposite side from the ink jet head in a vertical direction, and the recording medium supported by the recording medium support and to which the ink composition is attached has a surface temperature of 27° C. or higher and 38° C. or lower.

A recording apparatus according to an aspect of the present disclosure is a recording apparatus for performing the above-described recording method and includes the processing liquid; the ink composition; a processing liquid attaching mechanism that performs the attaching the processing liquid; the ink jet head; a transport mechanism that performs the transporting; the heating mechanism; and the recording medium support.

### BRIEF DESCRIPTION OF THE DRAWINGS

FIG. 1 is a front view schematically illustrating an example of a serial recording apparatus.

FIG. 2 is a bottom view partially illustrating a configuration example of an ink jet head.

FIG. 3 is a front view schematically illustrating another example of a serial recording apparatus.

FIG. 4 is a front view schematically illustrating another example of a serial recording apparatus.

FIG. 5 is a perspective view schematically illustrating another example of a serial recording apparatus.

FIG. 6 is a table (Table 1) indicating compositions and the like of composites used in Examples and Comparative Examples.

FIG. 7 is a table (Table 2) indicating conditions and evaluation results of Examples.

FIG. 8 is a table (Table 3) indicating conditions and evaluation results of Examples.

FIG. 9 is a table (Table 4) indicating conditions and evaluation results of Examples and Comparative Examples.

### DESCRIPTION OF EMBODIMENTS

Hereinafter, embodiments of the present disclosure will be described. The embodiments described below describe examples of the present disclosure. The present disclosure is not limited to the following embodiments, and includes various modifications made within a range not changing a gist of the present disclosure. It should be noted that not all of the configurations described below are essential configurations of the present disclosure.

### 1. RECORDING METHOD

A recording method according to this embodiment includes attaching a processing liquid containing an aggregating agent to a recording medium; ejecting and attaching an ink composition from an ink jet head to the recording medium; transporting the recording medium after the attaching the processing liquid and the attaching the ink composition to a heating mechanism; and heating the transported recording medium at the heating mechanism.

### 1.1. Recording Medium

The recording medium used in the recording method according to the embodiment is not particularly limited. Examples of the recording medium include an absorbent recording medium, a low-absorbent recording medium, and a non-absorbent recording medium. Among these, the low-absorbent recording medium and the non-absorbent recording medium are preferable, and the non-absorbent recording medium is more preferable. The present disclosure is advantageously used for a non-absorbent recording medium, which is particularly poor in filling properties.

Here, “low-absorbent recording medium” and “non-absorbent recording medium” refer to recording media in which the amount of water absorption from the start of contact to 30 msec is 10 mL/m² or less according to the Bristow method. The Bristow method is the most widely used method for measuring the amount of liquid absorption in a short time and has been adopted by Japan Technical Association of the Pulp and Paper Industry (JAPAN TAPPI). The details of the test method are described in Specification No. 51 “Paper and Cardboards-Liquid absorption Test Methods-Bristow Method” of “JAPAN TAPPI Paper and Pulp Test Methods 2000”.

Non-absorbent or low-absorbent recording media can also be classified according to the wettability of the recording surface with respect to water. For example, 0.5 μL of a water droplet is dropped onto a recording surface of a recording medium, and a decrease rate of the contact angle (comparison between the contact angle at 0.5 milliseconds after landing and the contact angle at 5 seconds after landing) is measured. This can characterize the recording medium. More specifically, as the properties of the recording medium, the “non-absorbent” indicates that the above-described decrease rate is less than 1%, the “low absorbent” indicates that the above-described decrease rate is 1% or more and less than 58, and the “absorbent” indicates that the above-described decrease rate is 5% or more. The contact angle can be measured using, for example, a portable contact angle meter PCA-1 (manufactured by Kyowa Interface Science Co., Ltd.).

The absorbent recording medium is not particularly limited and examples thereof include plain paper such as electrophotographic paper having high ink composition permeability, ink jet paper (paper for exclusive use in ink jet recording having an ink absorbing layer composed of silica particles or alumina particles or an ink absorbing layer composed of a hydrophilic polymer such as polyvinyl alcohol (PVA) or polyvinyl pyrrolidone (PVP)), art paper, coat paper, and cast paper, which have relatively low ink composition permeability and are used for general offset printing.

The low-absorbent recording medium is not particularly limited, and examples thereof include coated paper having a coating layer for receiving an oil-based ink on the surface. The coated paper is not particularly limited, and examples thereof include printing paper such as art paper, coat paper, and matte paper.

The non-absorbent recording medium is not particularly limited, and examples thereof include a plastic film not having an ink absorbing layer and a medium in which plastic is coated or plastic film is bonded on a base material such as paper. Examples of the plastic include polyvinyl chloride, polyethylene terephthalate, polycarbonate, polystyrene, polyurethane, polyethylene, and polypropylene.

The recording medium may have any shape as long as it can be transported at the transport step. For example, the shape may be an elongated shape that can be wound in the form of roll or the like or may be a single sheet having an A4 size or the like.

### 1.2. Processing Liquid Attaching Step

In the processing liquid attaching step, a processing liquid containing an aggregating agent is attached to a recording medium. The processing liquid attaching step can be performed simultaneously with the ink attaching step, or before or after the ink attaching step.

Examples of the processing liquid attaching method include immersion coating in which a recording medium is immersed in a processing liquid, roller coating in which a processing liquid is attached using a brush, roller, spatula, roll coater, or the like, spray coating in which a processing liquid is sprayed by a spray device or the like, and ink jet coating in which a processing liquid is attached by an ink jet method. Among these, the ink jet method is preferable.

### 1.2.1. Processing Liquid

The processing liquid used in the recording method according to the present embodiment is a water-based processing liquid containing an aggregating agent.

### 1.2.1. (1) Aggregating Agent

The processing liquid contains an aggregating agent that aggregates components of the ink composition. The aggregating agent has an effect of aggregating the coloring material and the resin particles by reacting with the components such as the coloring material contained in the ink and the resin particles that can be contained in the ink. However, the degree of aggregation of the coloring material and the resin particles by the aggregating agent varies depending on the type of each of the aggregating agent, the coloring material, and the resin particles, and can be adjusted. In addition, the aggregating agent can aggregate the coloring material and the resin particles by reacting with the coloring material and the resin particles contained in the ink. For example, such aggregation makes it possible to enhance the color development of the coloring material, the fixing properties of the resin particles, and/or the viscosity of the ink.

Although the aggregating agent is not particularly limited, examples thereof include a metal salt, an inorganic acid, an organic acid, and a cationic compound, and as the cationic compound, a cationic resin (cationic polymer), a cationic surfactant, and the like can be used. Among these, a polyvalent metal salt is preferable as the metal salt, and a cationic resin is preferable as the cationic compound. Thus, as the aggregating agent, it is preferable to select any one of a cationic resin, an organic acid, and a polyvalent metal salt because image quality, abrasion resistance, gloss, and the like to be obtained are particularly excellent.

The metal salt is preferably a polyvalent metal salt, but metal salts other than polyvalent metal salts can be used. Among these aggregating agents, it is preferable to use at least one selected from a metal salt and an organic acid because reactivity with components included in the ink is excellent. In addition, among the cationic compounds, cationic resins are preferably used because of its high solubility in the processing liquid. In addition, multiple kinds of aggregating agents can be used in combination.

The polyvalent metal salt is a compound composed of a divalent or higher valent metal ions and anions. Examples of the divalent or higher valent metal ions include ions of, for example, calcium, magnesium, copper, nickel, zinc, barium, aluminum, titanium, strontium, chromium, cobalt, and iron. Among the metal ions constituting these polyvalent metal salts, the metal ions are preferably at least one of a calcium ion and a magnesium ion because the aggregability of the components of the ink is excellent.

Examples of the anions constituting the polyvalent metal salt include an inorganic ion and an organic ion. In short, the polyvalent metal salt in the present disclosure is formed of an inorganic ion or an organic ion and a polyvalent metal. Examples of the inorganic ion include a chloride ion, a bromine ion, an iodine ion, a nitrate ion, a sulfate ion, and a hydroxide ion. Examples of the organic ion include an organic acid ion such as a carboxylic acid ion.

The polyvalent metal compound is preferably an ionic polyvalent metal salt, and in particular, the polyvalent metal salt is preferably a magnesium salt or a calcium salt, because the stability of the processing liquid is further improved. A calcium salt is particularly preferable. As a counter ion of the polyvalent metal, any of an inorganic acid ion and an organic acid ion may be used.

Specific examples of the polyvalent metal salt include calcium carbonate such as heavy calcium carbonate and light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium formate, calcium acetate, magnesium acetate, and aluminum acetate. These polyvalent metal salts may be used alone or in combination of two or more thereof. Among these, since sufficient solubility in water can be secured and the use thereof reduces traces of the processing liquid (makes traces less visible), at least any one of calcium formate, magnesium sulfate, calcium nitrate, and calcium chloride is preferable, and at least one of calcium formate and calcium nitrate is more preferable. The metal salts may have water of hydration in the raw material form.

Examples of the metal salt other than the polyvalent metal salt include monovalent metal salts such as sodium salts and potassium salts, and examples thereof include sodium sulfate and potassium sulfate.

Preferable examples of the organic acid include poly(meth)acrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidonecarboxylic acid, pyrone carboxylic acid, pyrrole carboxylic acid, furancarboxylic acid, pyridine carboxylic acid, coumaric acid, thiophene carboxylic acid, nicotinic acid, derivatives of these compounds, and salts thereof. The organic acid may be used alone or in combination of two or more thereof. Salts of organic acids that are metal salts are included in the above-mentioned metal salts.

Examples of the inorganic acid include sulfuric acid, hydrochloric acid, nitric acid, and phosphoric acid. The inorganic acids may be used alone or in combination of two or more thereof.

Examples of the cationic resin (cationic polymer) include cationic urethane resins, cationic olefin resins, and cationic amine resins. The cationic polymer is preferably water-soluble.

As the cationic urethane resin, commercially available products can be used, and examples thereof include HYDRAN CP-7010, CP-7020, CP-7030, CP-7040, CP-7050, CP-7060, and CP-7610 (trade names, manufactured by DIC Corporation), SUPERFLEX 600, 610, 620, 630, 640, and 650 (trade name, manufactured by DKS Co., Ltd.), urethane emulsion WBR-2120C and WBR-2122C (trade names, manufactured by Taisei Fine Chemical Co., Ltd.).

The cationic olefin resin is a resin having an olefin such as ethylene and propylene in the structural skeleton, and known ones can be appropriately selected and used. The cationic olefin resin may be in an emulsion state of being dispersed in a solvent containing water, an organic solvent, or the like. As the cationic olefin resin, a commercially available product can be used, and examples thereof include ARROWBASE CB-1200 and CD-1200 (trade name, manufactured by Unitika Ltd.).

As the cationic amine resin (cationic polymer), any resin having an amino group in the structure may be used, and known ones can be appropriately selected and used. Examples thereof include a polyamine resin, a polyamide resin, and a polyallylamine resin. The polyamine resin is a resin having an amino group in the main skeleton of the resin. The polyamide resin is a resin having an amide group in the main skeleton of the resin. The polyallylamine resin is a resin having a structure derived from an allyl group in the main skeleton of the resin.

Specific examples of the cationic polyamine resin include UNISENCE KHE103L (hexamethylene diamine/epichlorohydrin resin, pH of a 1% aqueous solution, approximately 5.0; viscosity, 20 to 50 (mPa·s); a 50% by mass solids aqueous solution) and UNISENCE KHE104L (dimethylamine/epichlorohydrin resin, pH of a 1% aqueous solution, approximately 7.0; viscosity, 1 to 10 (mPa·s); a 20% by mass solids aqueous solution) manufactured by Senka Co., Ltd. Furthermore, specific examples of commercially available products of the cationic polyamine resin include FL-14 (manufactured by SNF Co. Ltd.), ARAFIX 100, 251S, 255, and 255LOX (manufactured by Arakawa Chemical Industries, Ltd.), DK-6810, 6853, and 6885; and WS-4010, 4011, 4020, 4024, 4027, and 4030 (manufactured by Seiko PMC Corporation), PAPYOGEN P-105 (manufactured by Senka), Sumirez Resin 650 (30), 675A, 6615, and SLX-1 (manufactured by Taoka Chemical Co., Ltd.), Catiomaster (registered trademark) PD-1, 7, 30, A, PDT-2, PE-10, PE-30, DT-EH, EPA-SK01, and TMHMDA-E (manufactured by Yokkaichi Chemical Company, Limited), and Jetfix 36N, 38A, 5052 (manufactured by Satoda Kako Co., Ltd.).

Examples of the polyamine resin include a polyallylamine resin. Examples of the polyallylamine resin include polyallylamine hydrochloride, polyallylamineamide sulfate, allylamine hydrochloride-diallylamine hydrochloride copolymers, allylamine acetate-diallylamine acetate copolymers, allylamine acetate-diallylamine acetate copolymers, allylamine hydrochloride-dimethylallylamine hydrochloride copolymers, allylamine-dimethylallylamine copolymers, polydiallylamine hydrochloride, polymethyldiallylamine hydrochloride, polymethyldiallylamineamide sulfate, polymethyldiallylamine acetate, polydiallyldimethylammonium chloride, diallylamine acetate-sulfur dioxide copolymers, diallylmethylethylammonium ethylsulfate-sulfur dioxide copolymers, methyldiallylamine hydrochloride-sulfur dioxide copolymers, diallyldimethylammonium chloride-sulfur dioxide copolymers, and diallyldimethylammonium chloride-acrylamide copolymers.

These aggregating agents may be used in combination. In addition, when at least one of a polyvalent metal salt, an organic acid, and a cationic resin is selected from these aggregating agents, the aggregation action is more favorable, and thus it is possible to form an image having higher quality (particularly favorable color developing properties). As the aggregating agent, a polyvalent metal salt is more preferably used, and a calcium salt is still more preferably used. This can further improve the image quality of the produced image.

The total aggregating agent content of the processing liquid is, for example, 0.1% by mass or more and 20% by mass or less, preferably 18 by mass or more and 20% by mass or less, and more preferably 2% by mass or more and 15% by mass or less based on the total mass of the processing liquid. Even when the aggregating agent is common to both the solution and the dispersion, the solid content is preferably within the above range. When the aggregating agent content is in any of or greater than these ranges, the aggregating agent can sufficiently aggregate the components contained in the ink. When the aggregating agent content is in any of or less than these ranges, the solubility and dispersibility of the aggregating agent in the processing liquid are more favorable, improving the storage stability and the like of the processing liquid.

### 1.2.1. (2) Water

The processing liquid used in the recording method according to the embodiment may be a water-based processing liquid containing water. The “water-based” means that a composition contains water as a primary solvent. This makes it possible to perform recording with less environmental load and less odor or the like.

Water may be contained as a primary solvent of the processing liquid and is a component evaporated and scattered when dried. The water is preferably pure water or ultrapure water from which ionic impurities have been removed as much as possible, such as ion-exchanged water, ultrafiltered water, reverse osmosis water, or distilled water. The use of water sterilized by, for example, ultraviolet irradiation or addition of hydrogen peroxide is advantageous because it is possible to suppress the generation of molds or bacteria when the ink is stored for a long period of time. The water content is preferably 45% by mass or more based on the total amount of the processing liquid. The upper limit is, for example, 99% by mass or less. The water content is more preferably 50% by mass or more and 98% by mass or less, and still more preferably 55% by mass or more and 95% by mass or less.

### 1.2.1. (3) Surfactant

The processing liquid used in the recording method according to the embodiment may contain a surfactant. The surfactant is not particularly limited, and examples thereof include an acetylene glycol-based surfactant, a fluorine-based surfactant, and a silicone-based surfactant. The surfactant has a function of adjusting the surface tension of the processing liquid, for example, to adjust the wettability against the recording medium.

The acetylene glycol-based surfactant is not particularly limited, and examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (all trade names, manufactured by Air Products Japan, K.K.), Olfine B, Y, P, A, STG, SPC, E1004, E1010, PD-001, PD-002W, PD-003, PD-004, EXP.4001, EXP.4036, EXP.4051, AF-103, AF-104, AK-02, SK-14, and AE-3 (all trade names, manufactured by Nissin Chemical Industry Co., Ltd), and ACETYLENOL E00, EOOP, E40, and E100 (all trade names, manufactured by Kawaken Fine Chemicals Co., Ltd).

As the fluorine-based surfactant, a fluorine-modified polymer is preferably used, and specific examples thereof include BYK-340 (trade name, manufactured by BYK Japan KK).

The silicone-based surfactant is not particularly limited, and examples thereof preferably include a polysiloxane-based compound. The polysiloxane-based compound is not particularly limited, and examples thereof include polyether-modified organosiloxane. Examples of commercially available products of the polyether-modified organosiloxane include BYK-306, BYK-307, BYK-333, BYK-341, BYK-345, BYK-346, and BYK-348 (trade names, manufactured by BYK Japan KK), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, Shin-Etsu Chemical Co., Ltd), and SILFACE SAG503A and SILFACE SAG014 (trade names, manufactured by Nissin Chemical Industry Co., Ltd).

The surfactants may be used alone or in combination of two or more thereof. When the surfactant is contained, the surfactant content is preferably 0.1% by mass to 1.5% by mass based on the total mass of the ink jet ink composition.

### 1.2.1. (4) Other Components

The processing liquid may contain components such as a resin particle, an organic solvent, a surfactant, a wax, an additive, an antiseptic/antifungal agent, a rust inhibitor, a chelating agent, a viscosity modifier, an antioxidant, and an antifungal agent unless its functions are impaired. This will be sequentially described below.

### Resin Particle

The processing liquid may contain a resin particle. The resin particle may be able to further improve the adhesion of the image formed by the ink attached to the recording medium. Examples of the resin particle include particles of urethane resins, acrylic resins (including styrene-acrylic resin), fluorene resins, polyolefin resins, rosin-modified resins, terpene resins, polyester resins, polyamide resins, epoxy resins, vinyl chloride resins, vinyl chloride-vinyl acetate copolymers, and ethylene vinyl acetate resins. Among these, a urethane resin, an acrylic resin, a polyolefin resin, and a polyester resin are preferable. These resin particles are usually handled in emulsion form but may be handled in powder form. The resin particles can be used alone or in combination of two or more thereof.

The glass transition temperature (Tg) of the resin particles is preferably −50° C. or higher and 200° C. or lower, more preferably 0° C. or higher and 150° C. or lower, and still more preferably 50° C. or higher and 100° C. or lower. In particular, the glass transition temperature is preferably 50° C. or higher and 80° C. or lower. When the glass transition temperature (Tg) of the resin particle is within the above range, the resin particle tends to be excellent in durability and clogging resistance. The glass transition temperature is measured, for example, using a differential scanning calorimeter “DSC7000”, manufactured by Hitachi High-Tech Science Corporation, in accordance with JIS K7121 (Testing Methods for Transition Temperatures of Plastics).

The volume average particle diameter of the resin particles is preferably 10 nm or more and 300 nm or less, more preferably 30 nm or more and 300 nm or less, even more preferably 30 nm or more and 250 nm or less, and particularly preferably 40 nm or more and 220 nm or less. The volume average particle diameter can be measured by the method described above.

The acid value of the resin of the resin particle is preferably 50 mg KOH/g or less, more preferably 30 mg KOH/g or less, even more preferably 20 mg KOH/g or less, and particularly preferably 10 mg KOH/g or less. The lower limit of the acid value is 0 mg KOH/g or more, preferably 5 mg KOH/g or more, and more preferably 10 mg KOH/g or more. Furthermore, the lower limit is preferably 15 mg KOH/g or more. This is preferable because the image quality and the like are excellent. Furthermore, the acid value of the resin particle contained in the ink in any of or greater than the above ranges is preferable because in that case the viscosity increase ratio of the ink composition of the ink, which will be described later, can be readily set in any of or greater than ranges that will be described later. The acid value can be measured by the method described above.

The resin particle content of the processing liquid is preferably 20% by mass or less, more preferably 10% by mass or less, even more preferably 5% by mass or less, still more preferably 1% by mass or less, and particularly preferably 0.1% by mass or less on a solid basis based on the total mass of the processing liquid, and the processing liquid may contain no resin particles. However, when the resin particle is contained, the resin particle content is preferably 0.1% by mass or more, more preferably 18 by mass or more, and still more preferably 28 by mass or more.

The resin particle content of the ink is preferably 0.5% by mass or more, more preferably 18 by mass or more, and still more preferably 38 by mass or more on a solid basis based on the total mass of the ink. Furthermore, the resin particle content is preferably 20% by mass or less, more preferably 10% by mass or less, and still more preferably 8% by mass or less.

### Organic Solvent

The processing liquid used in the recording method according to the embodiment may contain an organic solvent. The organic solvent is preferably water-soluble. One of the functions of the organic solvent is to improve the wettability of the processing liquid against the recording medium or to increase the moisture retention of the processing liquid. Furthermore, the organic solvent can also function as a humectant or a penetrant.

Examples of the organic solvent include esters, alkylene glycol ethers, cyclic esters, nitrogen-containing solvents, and polyhydric alcohols. Examples of the nitrogen-containing solvents include cyclic amides and acyclic amides. Examples of the acyclic amides include alkoxyalkylamides.

Examples of the esters include glycol monoacetates such as ethylene glycol monomethyl ether acetate, ethylene glycol monoethyl ether acetate, and ethylene glycol monobutyl ether acetate, and glycol diesters such as ethylene glycol diacetate, diethylene glycol diacetate, and propylene glycol diacetate.

The alkylene glycol ethers may be alkylene glycol monoethers or diethers, and alkyl ethers are preferable. Specific examples thereof include alkylene glycol monoalkyl ethers such as ethylene glycol monomethyl ether, ethylene glycol monoethyl ether, ethylene glycol monoisopropyl ether, and ethylene glycol monobutyl ether, diethylene glycol monomethyl ether, and alkylene glycol dialkyl ethers such as ethylene glycol dimethyl ether, ethylene glycol diethyl ether, ethylene glycol dibutyl ether, diethylene glycol dimethyl ether, and diethylene glycol diethyl ether.

Examples of the cyclic esters include cyclic esters (lactones) such as β-propiolactone, γ-butyrolactone, δ-valerolactone, ε-caprolactone, and β-butyrolactone, and compounds in which a hydrogen of a methylene group adjacent to a carbonyl group thereof is substituted with an alkyl group having 1 to 4 carbon atoms.

Examples of the alkoxyalkylamides include 3-methoxy-N, N-dimethylpropionamide, 3-methoxy-N, N-diethylpropionamide, 3-methoxy-N, N-methylethylpropionamide, 3-ethoxy-N, N-dimethylpropionamide, 3-ethoxy-N, N-diethylpropionamide, 3-ethoxy-N, N-methylethylpropionamide, 3-n-butoxy-N, N-dimethylpropionamide, 3-n-butoxy-N, N-diethylpropionamide, and 3-n-butoxy-N, N-methylethylpropionamide.

Examples of the cyclic amides include lactams, and examples thereof include pyrrolidones such as 2-pyrrolidone, 1-methyl-2-pyrrolidone, 1-ethyl-2-pyrrolidone, 1-propyl-2-pyrrolidone, and 1-butyl-2-pyrrolidone. These are preferable from the viewpoint of solubility of the aggregating agent and promotion of film formation of the resin particles described below, and 2-pyrrolidone is particularly preferable.

In addition, it is also preferable to use a compound represented by Formula (1) as the alkoxyalkylamides.

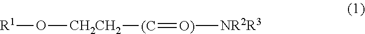

In Formula (1), R¹ represents an alkyl group having 1 or more and 4 or less carbon atoms, and R² and R³ each independently represent a methyl group or an ethyl group. The “alkyl group having 1 or more and 4 or less carbon atoms” may be a linear or branched alkyl group, and examples thereof include a methyl group, an ethyl group, an n-propyl group, an iso-propyl group, an n-butyl group, a sec-butyl group, an iso-butyl group, and a tert-butyl group. The compounds represented by Formula (1) may be used alone or in combination of two or more thereof.

The function of the nitrogen-containing solvent is, for example, to enhance the surface drying properties and the fixing properties of the processing liquid attached to the low-absorbent recording medium. In particular, the compound represented by Formula (1) is excellent in the action of moderately softening and dissolving a vinyl chloride resin. Thus, the compound represented by Formula (1) can soften and dissolve the recording surface containing the vinyl chloride resin to allow the processing liquid to permeate into the low-absorbent recording medium. When the processing liquid permeates into the low-absorbent recording medium in this manner, the processing liquid is firmly fixed, and the surface of the processing liquid is easily dried. Accordingly, the produced image is likely to have excellent surface drying properties and fixing properties.

When the processing liquid contains the nitrogen-containing solvent, the nitrogen-containing solvent content is preferably not more than 15% by mass, more preferably not more than 10% by mass, and still more preferably not more than 5% by mass based on the total mass of the processing liquid. Furthermore, the content is preferably not more than 2% by mass, and more preferably not more than 1% by mass.

In particular, it is preferable that the processing liquid does not contain the amide solvent. This can further improve the graininess and the abrasion resistance of the produced image.

Examples of the polyhydric alcohols include 1,2-alkanediol (for example, alkanediols such as ethylene glycol, propylene glycol (also known as propane-1,2-diol), 1,2-butanediol, 1,2-pentanediol, 1,2-hexanediol, 1,2-heptanediol, and 1,2-octanediol), and polyhydric alcohols (polyols) excluding the 1,2-alkanediol (for example, diethylene glycol, dipropylene glycol, 1,3-propanediol, 1,3-butanediol (also known as 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylol propane, and glycerin).

Examples of the polyhydric alcohols include alkanediols and polyols. Among the alkanediols, an alkanediol having 5 or more carbon atoms is preferable. The number of carbon atoms of the alkane is preferably 5 to 10, more preferably 5 to 8, and even more preferably 5 to 6. Preferable examples include 1,2-alkanediol and propyleneglycol. Among them, 1,2-alkanediol is preferable.

Examples of the polyols include alkanediols having 4 or less carbon atoms, intermolecular condensates of hydroxyl groups of alkanediols, and alkanepolyols of triol or more.

The number of carbon atoms of the alkane is preferably 2 to 3. The number of hydroxyl groups in the molecule of the polyols is 2 or more, preferably 5 or less, and more preferably 3 or less. When the polyols are the intermolecular condensates described above, the number of intermolecular condensates is 2 or more, preferably 4 or less, and more preferably 3 or less. The polyhydric alcohols may be used alone or in combination of two or more thereof.

The alkanediols and polyols can mainly function as a penetrating solvent and/or a moisturizing solvent. However, the alkanediols tend to have strong properties as the penetrating solvent, and polyols tend to have strong properties as the moisturizing solvent.

The processing liquid may contain an organic solvent that is a polyhydric alcohol having a normal boiling point of 170° C. or more and 240° C. or less, and this is preferable because the graininess and abrasion resistance of the image can be further improved. The processing liquid more preferably contains an organic solvent that is a polyol having a normal boiling point of 170° C. or more and 240° C. or less. This is more preferable from the above-described point.

When the processing liquid contains an organic solvent, the organic solvent may be used alone or in combination of two or more thereof. The total content of the organic solvent based on the total mass of the processing liquid is, for example, 18 by mass or more and 50% by mass or less.

Furthermore, the above content is preferably 5% by mass or more and 50% by mass or less, preferably 10% by mass or more and 45% by mass or less, more preferably 15% by mass or more and 40% by mass or less, and still more preferably 20% by mass or more and 40% by mass or less. Furthermore, the content is more preferably 25 to 35% by mass. When the organic solvent content is within the above ranges, the balance between wet spreadability and dryness is further improved, and an image having high image quality is easily formed.

It is also preferable that the content of the organic solvent that is a polyol having a normal boiling point of 170° C. or more and 240° C. or less be any of the above ranges. It is also preferable that the content of the organic solvent that is a polyhydric alcohol having a normal boiling point of 170° C. or more and 240° C. or less be in any of the above ranges.

The processing liquid preferably does not contain a polyhydric alcohol having a normal boiling point of higher than 280° C. in an amount of 18 by mass or more, more preferably 0.5% by mass or more, with respect to the processing liquid. Furthermore, it is also preferable that the content of the organic solvent other than the polyhydric alcohol and having a normal boiling point of more than 280° C. be in any of the above ranges.

### Wax

The processing liquid may contain a wax. Since the wax has a function of imparting lubricity to an image formed by the ink, peeling of the image or the like can be reduced in some cases.

Examples of the components constituting the wax include plant or animal waxes such as carnauba wax, candelilla wax, beeswax, rice wax, and lanolin; petrolatum waxes, such as paraffin wax, microcrystalline wax, polyethylene wax, oxidized polyethylene wax, and petrolatum; mineral waxes, such as montan wax and ozokerite; synthetic waxes such as carbon wax, Hoechst wax, polyolefin wax, and stearic acid amide; and emulsions of natural synthetic waxes or compounded waxes such as an α-olefin maleic anhydride copolymer. These waxes can be used alone or in combination of two or more thereof. Among these, polyolefin wax (particularly, polyethylene wax and polypropylene wax) and paraffin wax are preferably used because they are more excellent in the effect of enhancing the fixing properties to the soft packaging film described later.

As the wax, a commercially available product can be used as it is, and examples thereof include NOPCOTE PEM-17 (trade name, manufactured by SAN NOPCO LIMITED), CHEMIPEARL W4005 (trade name, manufactured by Mitsui Chemicals, Inc.), and AQUACER 515, 539, and 593 (all trade names, manufactured by BYK Japan KK.).

Furthermore, since the recording method includes a heating step or the like, it is preferable to use a wax having a melting point of preferably 50° C. or more and 200° C. or less, more preferably 70° C. or more and 180° C. or less, and even more preferably 90° C. or more and 150° C. or less, to suppress a decrease in performance due to excessive melting of the wax.

The wax may be supplied in the form of an emulsion or suspension. The wax content is 0.1% by mass or more and 10% by mass or less, more preferably 0.5% by mass or more and 5% by mass or less, and still more preferably 0.5% by mass or more and 2% by mass or less in terms of solid content based on the total mass of the processing liquid. When the wax content is within the above range, the function of the wax can be satisfactorily exhibited. In addition, when at least one of the processing liquid, a clear ink composition, which will be described later, an ink composition, and an ink composition, contain wax, it is possible to more sufficiently obtain a function of imparting lubricity to an image.

### Additive

The processing liquid may contain ureas, amines, saccharides and the like as additives. Specific examples of the ureas include urea, ethyleneurea, tetramethylurea, thiourea, 1,3-dimethyl-2-imidazolidinone, and betaines (such as trimethylglycine, triethylglycine, tripropylglycine, triisopropylglycine, N, N, N-trimethylalanine, N, N, N-triethylalanine, N, N, N-triisopropylalanine, N, N, N-trimethylmethylalanine, camitine, and acetylcamitine).

Examples of the amines include diethanolamine, triethanolamine, and triisopropanolamine. The ureas or amines may function as a pH adjuster.

Examples of the saccharides include glucose, mannose, fructose, ribose, xylose, arabinose, galactose, aldonic acid, glucitol (sorbitol), maltose, cellobiose, lactose, sucrose, trehalose, and maltotriose.

### Others

The processing liquid used in the recording method according to the embodiment may further contain a component such as an antiseptic/fungicide, a rust inhibitor, a chelating agent, a viscosity modifier, an antioxidant, and an antifungal agent, as necessary.

### 1.2.1.(5) Physical Properties of Processing Liquid

The processing liquid used in the recording method of the present embodiment preferably has a surface tension at 25° C. of 40 mN/m or less, preferably 38 mN/m or less, more preferably 35 mN/m or less, and even more preferably 30 mN/m or less, to achieve appropriate wetting and spreading properties on a recording medium. The surface tension can be determined by confirming a surface tension measured by using an automatic surface tensiometer CBVP-Z (manufactured by Kyowa Interface Science Co., Ltd) when a platinum plate is wetted with the composition under an environment of 25° C.

The processing liquid is more preferably attached to the recording medium by an ink jet method. In such a case, the viscosity at 20° C. is preferably 1.5 mPa·s or more and 15 mPa·s or less, more preferably 1.5 mPa·s or more and 7 mPa·s or less, and still more preferably 1.5 mPas or more and 5.5 mPa's or less. When the processing liquid is attached to the recording medium by the ink jet method, it is easy to efficiently form a predetermined processing liquid attachment area on the recording medium.

### 1.2.2. Method for Attaching Processing Liquid to Recording Medium

The processing liquid attaching step may be performed by various methods such as a roller method, a spray method, a dip method, and an ink jet method. In particular, an ink jet method, which ejects and attaches ink from an ink jet head to a recording medium, is preferable, because the attachment amount and the attachment position can be readily controlled.

In such a case, for example, the processing liquid may be attached during relative positional movement between the ink jet head and the recording medium, i.e., scanning, and this can be performed by any method. Examples of the ink jet type include a serial type and a line type. This enables a small apparatus to efficiently perform small-volume and multi-type printing.

The attachment amount of the processing liquid in the processing liquid attaching step is preferably 0.4 mg/inch² or more. Furthermore, the attachment amount is preferably 0.5 mg/inch² or more, more preferably 1.0 mg/inch² or more, further preferably 1.5 mg/inch² or more, and even more preferably 2.0 mg/inch² or more. This enables production of an image having better filling properties. In addition, it is preferable that the maximum attachment amount of the processing liquid at the processing liquid attaching step be equal to or greater than the above ranges.

The upper limit of the attachment amount of the processing liquid at the processing liquid attaching step is preferably 5.0 mg/inch² or less. The upper limit is more preferably 3.0 mg/inch² or less, still more preferably 2.5 mg/inch² or less, and still more preferably 2.0 mg/inch² or less. In particular, the maximum attachment amount of the processing liquid at the processing liquid attaching step may be equal to or less than the above range, which is preferable.

When the attachment amount is equal to or greater than the above range, an image is likely to have graininess, but even in such a case, the effect of suppressing graininess, which is the effect of the recording method of the present embodiment, is more remarkably exhibited.

In addition, when the processing liquid attaching step is performed by an ink jet method, the mass (ng) of the liquid droplet of the processing liquid is preferably 0.5 ng or more and 10 ng or less, more preferably 1 ng or more and 7 ng or less, even more preferably 1 ng or more and 5 ng or less, and still even more preferably 2 ng or more and 4 ng or less. The mass (ng) of the droplet of the processing liquid in the processing liquid attaching step is, in terms of dot size (ng/dot), preferably 0.5 ng/dot or more and 10 ng/dot or less, more preferably 1 ng/dot or more and 7 ng/dot or less, further preferably 1 ng/dot or more and 5 ng/dot or less, and still further preferably 2 ng/dot or more and 4 ng/dot or less.

After the processing liquid is attached to the recording medium in the processing liquid attaching step, the ink attaching step may be performed to attach ink to the recording medium. Alternatively, the processing liquid attaching step may attach the processing liquid to the same scanning region in the same scanning as the scanning (pass) in which the ink composition is attached to the recording medium.

The processing liquid attaching step is performed so that the ink composition attached to the recording medium at the ink attaching step and the processing liquid attached to the recording medium at the processing liquid attaching step can come into contact with each other and react on the recording medium.

### 1.3. Ink Attaching Step

In the ink attaching step, the ink composition is ejected from an ink jet head and attached to a recording medium. The ink attaching step is performed on the recording medium supported by the recording medium support, and the surface temperature of the recording medium subjected to the ink attaching step while supported by the recording medium support is 27° C. or higher and 38° C. or lower. The surface temperature is preferably 28° C. or higher and 35° C. or lower, more preferably 29° C. or higher and 33° C. or lower. When the surface temperature is in any of or higher than these ranges, shading unevenness and the like is more likely to be reduced, and when the surface temperature is in any of or lower than these ranges, filling and pinholes, clogging, and water condensation are more likely to be reduced.

The surface temperature of the recording medium subjected to the ink attaching step is 27° C. or higher and 38° C. or lower because the recording medium is heated by heat of a heating mechanism, which will be described later. Since the recording medium support (platen), which will be described later, does not have a device for conductively heating the recording medium supported by the recording medium support, the surface temperature of the recording medium which is subjected to the ink attaching step is heated to 27° C. or higher and 38° C. or lower by the heat of the heating mechanism. In short, the surface temperature of the recording medium to which the ink is attached is heated to 27° C. or higher and 38° C. or lower by the residual heat from the heating mechanism. The recording medium support will be described in detail later.

### 1.3.1. Ink Composition

The ink composition used in the recording method of the present embodiment may contain the following components.

### 1.3.1. (1) Coloring Material

The ink composition may contain a coloring material. Examples of the coloring material include a dye and a pigment. The coloring material may be a color coloring material such as a cyan, yellow, magenta, and black, or white coloring material. In addition, special color inks such as red, orange, blue, and green, and light color inks such as light magenta, light cyan, and gray may be used.

The coloring material may be either a dye or a pigment, or may be a mixture thereof. However, among a dye and a pigment, it is more preferable to include a pigment. The pigment is excellent in storage stability such as light resistance, weather resistance, and gas resistance, and is preferably an organic pigment from that point.

Specific examples of the pigment include azo pigments such as insoluble azo pigments, condensed azo pigments, azo lakes, and chelated azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelates, dye lakes, nitro pigments, nitroso pigments, aniline black, daylight fluorescent pigments, and carbon black. These pigments may be used alone or in combination of two or more thereof. Furthermore, a brilliant pigment may be used as the coloring material.

Specific examples of the pigment are not particularly limited, but examples thereof include the following.

Examples of black pigments include No. 2300, No. 900, MCF 88, No. 33, No. 40, No. 45, No. 52, MA7, MA8, MA100, and No. 2200B (all manufactured by Mitsubishi Chemical Corporation), Raven 5750, Raven 5250, Raven 5000, Raven 3500, Raven 1255, and Raven 700 (all manufactured by Columbia Carbon Inc.), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (manufactured by CABOT JAPAN K.K.), Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (all manufactured by Degussa).

Examples of yellow pigments include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of magenta pigments include C. I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, and C.I. Pigment Violet 19, 23, 32, 33, 36, 38, 43, and 50.

Examples of cyan pigments include C.I. Pigment Blue 1, 2, 3, 15, 15:1, 15:2, 15:3, 15:34, 15:4, 16, 18, 22, 25, 60, 65, and 66, and C.I. Bat blue 4 and 60.

In addition, pigments other than the magenta, cyan, and yellow pigments are not particularly limited and examples thereof include C.I. Pigment Green 7, 10, C.I. Pigment Brown 3, 5, 25, 26, and C.I. Pigment Orange 1, 2, 5, 7, 13, 14, 15, 16, 24, 34, 36, 38, 40, 43, and 63.

The pearl pigment is not particularly limited and examples thereof include pigments having pearl luster or interference luster such as titanium dioxide coated mica, fish scale foil, and bismuth acid chloride.

The metallic pigment is not particularly limited and examples thereof include elemental metal particles or alloy particles of metals such as aluminum, silver, gold, platinum, nickel, chromium, tin, zinc, indium, titanium, and copper.

Examples of the white coloring material include metal compounds such as metal oxides, barium sulfate, and calcium carbonate. Examples of the metal oxide include titanium dioxide, zinc oxide, silica, alumina, and magnesium oxide. In addition, particles having a hollow structure may be used as the white coloring material, and as the particles having a hollow structure, known particles can be used. As the white coloring material, among the exemplified materials, titanium dioxide is preferably used because of the good whiteness and abrasion resistance.

In addition, as dyes, for example, various dyes normally used for ink jet recording, such as direct dyes, acidic dyes, edible dyes, basic dyes, reactive dyes, dispersion dyes, construction dyes, soluble construction dyes, and reaction dispersion dyes can be used.

It is preferable that the coloring material can be stably dispersed or dissolved in a dispersion medium, and the coloring material may be dispersed using a dispersant as necessary.

It is preferable that the coloring material can be stably dispersed in the dispersion medium, and therefore, the coloring material may be dispersed using a dispersant. Examples of the dispersant include a resin dispersant, and the dispersant is selected from dispersants capable of improving the dispersion stability of the coloring material in the ink composition. In addition, the coloring material may be used as a self-dispersible pigment by oxidizing or sulfonating the surface of the pigment with, for example, ozone, hypochlorous acid, or fuming sulfuric acid to modify the surface of the pigment particle.

Examples of the resin dispersant (dispersant resin) include (meth)acrylic resins such as poly(meth)acrylic acid, (meth)acrylic acid-acrylonitrile copolymers, (meth)acrylic acid-(meth)acrylic acid ester copolymers, vinyl acetate-(meth)acrylic acid ester copolymers, vinyl acetate-(meth)acrylic acid copolymers, and vinyl naphthalene-(meth)acrylic acid copolymers, and salts thereof; styrene resins such as styrene-(meth)acrylic acid copolymers, styrene-(meth)acrylic acid-(meth)acrylic acid ester copolymers, styrene-α-methylstyrene-(meth)acrylic acid copolymers, styrene-α-methylstyrene-(meth)acrylic acid-(meth)acrylic acid ester copolymers, styrene-maleic acid copolymers, and styrene-maleic acid anhydride copolymers, and salts thereof; urethane resins, which are polymer compounds (resins) having a urethane bond formed when an isocyanate group reacts with a hydroxyl group, and which may be linear and/or branched regardless of whether being cross-linked or not, and salts thereof; polyvinyl alcohols; vinyl naphthalene-maleic acid copolymers and salts thereof; vinyl acetate-maleic acid ester copolymers and salts thereof; and water-soluble resins such as vinyl acetate-crotonic acid copolymers and salts thereof. Among these, a copolymer of a monomer having a hydrophobic functional group and a monomer having a hydrophilic functional group, and a polymer including a monomer having both a hydrophobic functional group and a hydrophilic functional group are preferable. As the form of the copolymer, any form of a random copolymer, a block copolymer, an alternating copolymer, and a graft copolymer can be used. Among the styrene resins, a copolymer with a (meth)acrylic monomer is also a (meth) acrylic resin.

Examples of commercially available products of the styrene resin dispersants include X-200, X-1, X-205, X-220, and X-228 (manufactured by SEIKO PMC CORPORATION), NOPCOSPERSE (registered trademark) 6100 and 6110 (manufactured by SAN NOPCO LIMITED), JONCRYL 67, 586, 611, 678, 680, 682, and 819 (manufactured by BASF SE), DISPER BYK-190 (manufactured by BYK Japan KK.), and N-EA137, N-EA157, N-EA167, N-EA177, N-EA197D, N-EA207D, and E-EN10 (manufactured by DKS Co., Ltd.).

In addition, examples of commercially available products of the acrylic resin dispersants include BYK-187, BYK-190, BYK-191, BYK-194N, and BYK-199 (manufactured by BYK Japan KK.), and Aron A-210, A6114, AS-1100, AS-1800, A-30SL, A-7250, and CL-2 manufactured by TOAGOSEI CO., LTD.).

Furthermore, examples of commercially available products of the urethane resin dispersant include BYK-182, BYK-183, BYK-184, and BYK-185 (manufactured by BYK Japan KK.), TEGO Dispers 710 (manufactured by Evonik Tego Chemie GmbH), and Borchi (registered trademark) Gen 1350 (manufactured by OMG Borchers GmbH).

These dispersants may be used alone or in combination of two or more thereof. The total dispersant content is preferably 0.1 parts by mass or more and 30 parts by mass or less, more preferably 0.5 parts by mass or more and 25 parts by mass or less, further more preferably 1 part by mass or more and 20 parts by mass or less, and still further more preferably 1.5 parts by mass or more and 15 parts by mass or less based on 50 parts by mass of the white coloring material. When the dispersant content is 0.1 parts by mass or more based on 50 parts by mass of the coloring material, the dispersion stability of the coloring material can be further improved. In addition, when the dispersant content is 30 parts by mass or less based on 50 parts by mass of the coloring material, the viscosity of the obtained dispersion can be suppressed to be small.

Among the dispersants exemplified above, at least one selected from anionic dispersant resins is more preferable. In this case, it is more preferable that a weight average molecular weight of the dispersant be 500 or more. Furthermore, the weight average molecular weight is preferably 5,000 or more and 100,000 or less, and more preferably 10,000 or more and 50,000 or less.

By using such a resin dispersant as the dispersant, the dispersibility and aggregability of the pigment is further improved, and an image having better dispersion stability and higher image quality can be produced. In addition, this makes it easier to increase the viscosity increase ratio of the ink composition, which will be described later, by 5 times or more and is preferable.

The anionic dispersant resin is a resin in which the resin has an anionic functional group and exhibits anionic properties. Examples of the anionic functional group include a carboxyl group, a sulfo group, and a phosphoric acid group. Among these groups, a carboxyl group is more preferable.

The dispersant resin may or may not have an acid value, and preferably has an acid value. The acid value is preferably 5 mg KOH/g or more. Furthermore, the acid value is preferably 250 mg KOH/g or less.

Furthermore, the acid value is more preferably 10 to 200 mg KOH/g, and further preferably 15 to 150 mg KOH/g. Furthermore, the acid value is preferably 20 to 100 mg KOH/g, and more preferably 30 to 80 mg KOH/g. Furthermore, the lower limit is preferably 40 mg KOH/g or more, more preferably 50 mg KOH/g or more, particularly preferably 60 mg KOH/g or more, and particularly more preferably 70 mg KOH/g or more. Furthermore, 80 mg KOH/g or more is preferable. The acid value in any of or greater than these ranges is preferable because in that case the viscosity increase ratio of the ink composition, which will be described later, can be readily made 5 times or more.

The acid value can be measured by the neutralization titration method in accordance with JIS K0070. As a titration device, for example, “AT610” manufactured by Kyoto Electronics Manufacturing Co., Ltd. can be used.

The coloring material content is preferably 0.3% by mass or more and 20% by mass or less, and more preferably 0.5% by mass or more and 15% by mass or less based on the total mass of the ink composition. Further, the content is preferably 18 by mass or more and 10% by mass or less, and more preferably 2% by mass or more and 7% by mass or less. When white ink is used, the content is preferably in the above range, more preferably 5% by mass or more and 17% by mass or less, and still more preferably 8% by mass or more and 13% by mass or less.

When a pigment is used as the coloring material, the volume-average particle size of the pigment is preferably 10 nm or more and 300 nm or less, more preferably 30 nm or more and 250 nm or less, still more preferably 50 nm or more and 250 nm or less, and particularly preferably 70 nm or more and 200 nm or less. Furthermore, the volume average particle diameter is preferably 80 nm or more and 150 nm or less. The volume average particle diameter of the coloring material is measured as an initial state by the above-described method for determining the volume average particle diameter. The volume average particle diameter in any of the above ranges is preferable because a desired coloring material is easily obtained and the characteristics of the coloring material are easily improved.

### 1.3.1. (2) Water

The ink composition used in the recording method according to the embodiment is an aqueous ink containing water. The “water-based” means that a composition contains water as a primary solvent. This makes it possible to perform recording with less environmental load and less odor or the like. The water and the water content may be the same as those of the above-described processing liquid, and the description thereof will not be described.

### 1.3.1. (3) Other Components

The ink composition may contain components such as a resin particle, an organic solvent, a surfactant, wax, an additive, an antiseptic/fungicide, a rust inhibitor, a chelating agent, a viscosity modifier, an antioxidant, and an antifungal agent.

In the ink composition, components other than the coloring material and the aggregating agent are the same as those which can be used in the processing liquid, and can be selected independently of the processing liquid. These components may be the same as those of the processing liquid described above, and a detailed description thereof will be omitted by replacing the “processing liquid” with the “ink composition”.

When the ink composition contains an organic solvent, the organic solvent content is preferably, for example, 1% by mass or more based on the total mass of the ink composition. Furthermore, the content is preferably 5 mass % or more and 40 mass % or less, more preferably 10 mass or more and 35 mass % or less, and still more preferably 12 mass % or more and 30 mass % or less. The content is more preferably 15 to 27% by mass, and still more preferably 20 to 25% by mass.

This makes it easy to achieve both suppression of clogging of the nozzles and improvement of drying of the image. When the ink composition contains an organic solvent, the content in any of or less than the above ranges is preferable because in that case the reaction with the processing liquid is accelerated, which results in further reduction of the shading unevenness, and the ink drying properties are improved, which results in further improvement in the abrasion resistance. Furthermore, the content in any of or greater than the above ranges is more preferable because in that case the speed of the reaction with the reaction liquid is lowered, the filling property is excellent, and the suppression of pinholes is excellent.

In addition, when the organic solvent content is within the above ranges, it is easy to balance image quality, filling, clogging, water condensation, abrasion resistance, and drying properties of the ink.

### 1.3.1.(4) Physical Properties of Ink Composition

The ink composition used in the recording method of the present embodiment has a surface tension at 25° C. of 40 mN/m or less, preferably 38 mN/m or less, more preferably 35 mN/m or less, and still more preferably 30 mN/m or less, to achieve appropriate wetting and spreading properties on a recording medium. The surface tension can be determined by confirming a surface tension measured by using an automatic surface tensiometer CBVP-Z (manufactured by Kyowa Interface Science Co., Ltd) when a platinum plate is wetted with the composition under an environment of 25° C.

The ink composition is attached to a recording medium by an ink jet method. Thus, the viscosity at 20° C. is preferably 1.5 mPa·s or more and 15 mPa·s or less, more preferably 1.5 mPa's or more and 7 mPa·s or less, and still more preferably 1.5 mPa's or more and 5.5 mPa's or less.

### 1.3.2. Viscosity Increase Ratio of Ink Composition

The ink composition preferably exhibits a viscosity increase ratio of 5 times or more when mixed with a 7% by mass aqueous solution of calcium formate at a mass ratio (ink composition: 7% by mass aqueous solution of calcium formate) of 10:1. The ink composition having such a viscosity can have sufficient aggregability of the components of the ink composition when the ink composition comes into contact with the processing liquid, and thus the image formed by the ink composition has further improved image quality. This can further reduce the shading unevenness of the produced image.

Regarding the viscosity increase ratio of the ink composition, i.e., the increase in the viscosity of the ink when mixed with a 7% by mass aqueous solution of calcium formate, the “viscosity increase ratio” is defined as follows. That is, the viscosity increase ratio is a ratio (times) of the viscosity of the mixture to the viscosity of the ink before mixing when the ink and the processing liquid used in the recording method are mixed and stirred at a mass ratio of 10:1. The viscosity is measured at 20° C.

The viscosity increase ratio is a magnification ratio of the viscosity after mixing to the viscosity before mixing. The viscosity increase ratio is, for example, about 0.5 times or more and about 10.0 times or less. Depending on the composition of the ink, the viscosity increase ratio may be less than 1.0 times, which results in a decrease in the viscosity, but this is referred to as the viscosity increase ratio. The viscosity can be measured using a rheometer. At the time of viscosity measurement, the mixed solution is stirred well and then sampled.

The lower limit of the viscosity increase ratio of the ink composition is preferably 2 times or more, more preferably 3 times or more, and still more preferably 5 times or more, but is more preferably more than 5 times, more preferably 5.5 times or more, still more preferably 6 times or more, and particularly preferably 7 times or more. Furthermore, the lower limit is preferably 10 times or more. This enables formation of an image having better image quality.

In contrast, the upper limit of the viscosity increase ratio of the ink composition is not limited, but is preferably 20 times or less, more preferably 10 times or less, even more preferably 9 times or less, even more preferably 8.5 times or less, and even still more preferably 8 times or less. The viscosity increase ratio of the ink composition in the above ranges is preferable because in that case the image quality, crack resistance, abrasion resistance, ejection stability, and the like are more excellent. Further, the image quality of the obtained image is also excellent, and in particular, graininess can be reduced.

The viscosity increase ratio of the ink composition can be controlled mainly by adjusting the type, amount, and the like of the pigment (including the resin dispersant) and the resin particle. In particular, control by adjusting the type, amount, and the like of the pigment (including a resin dispersant) is easy and preferable.

### 1.3.3. Method of Attaching Ink Composition to Recording Medium

In the ink attaching step, the ink composition is ejected from an ink jet head so as to be attached to a recording medium. In the ink attaching step, it is preferable that the ink composition be attached during scanning in which the relative position between the ink jet head and the recording medium is moved, and the ink attaching step may be performed by any type of method. Examples of the scanning of the ink jet type include a serial type and a line type. This enables a small apparatus to efficiently perform small-volume and multi-type printing.

In the ink attaching step, a plurality of types of ink compositions may be attached to the recording medium. For example, in the ink attaching step, a non-white ink containing a non-white coloring material and a white ink containing a white coloring material may be attached to the recording medium. In such a case, the number of the non-white inks may be two or more. For example, ink compositions of cyan, magenta, yellow, black, and white may be attached to the recording medium at the ink attaching step.

The maximum attachment amount of the ink composition at the ink attaching step is preferably 1.5 mg/inch² or more. Furthermore, the maximum attachment amount is preferably 3.0 mg/inch² or more, and more preferably 4.0 mg/inch² or more. Furthermore, the maximum attachment amount is preferably 5.0 mg/inch² or more. Furthermore, the maximum attachment amount is preferably 25 mg/inch² or less, more preferably 20 mg/inch² or less, and further more preferably 15 mg/inch² or less.

Furthermore, the maximum attachment amount is preferably 11.0 mg/inch² or less, more preferably 10.0 mg/inch² or less. Furthermore, the maximum attachment amount is preferably 9.0 mg/inch² or less, more preferably 7.0 mg/inch² or less. This enables production of an image having better filling properties. The attachment amount is the total ink attachment amount of the aqueous ink containing the coloring material used for recording.

In addition, the mass (ng) of the liquid droplets of the ink composition at the ink attaching step is preferably 8 ng or less, more preferably 1 ng or more and 8 ng or less, even more preferably 1 ng or more and 7 ng or less, and still more preferably 2 ng or more and 6 ng or less. The mass (ng) of the liquid droplets of the ink composition at the ink attaching step is, in terms of dot size (ng/dot), preferably 8 ng/dot or less, more preferably 1 ng/dot or more and 8 ng/dot or less, even more preferably 1 ng/dot or more and 7 ng/dot or less, and still more preferably 2 ng/dot or more and 6 ng/dot or less.

After the processing liquid is attached to the recording medium at the processing liquid attaching step, the ink is attached to the recording medium at the ink attaching step. In addition, at the ink attaching step, the ink composition may be attached to the same scanning region in the same scanning as the scanning (pass) in which the processing liquid is attached to the recording medium.

### 1.4. Transport Step

At the transport step, the recording medium is transported to the heating mechanism after the processing liquid attaching step and the ink attaching step. The recording medium is transported by an ordinary method using a roller, a guide, or the like. The heating mechanism will be described later.

### 1.5. Heating Step

In the heating step, the recording medium transported at the transport step is heated by the heating mechanism. The heating step can be performed using, for example, an appropriate heating unit (heating mechanism). The heating step is performed by, for example, a heater. This enables the produced image to be dried and more sufficiently fixed, and thus, for example, the recorded matter can be put in an available state at an early stage.

The temperature of the recording medium reached when heated by the heating mechanism is not particularly limited, but may be set in consideration of, for example, the glass transition temperature (Tg) of the resin component constituting the resin particle contained in the recorded matter. In the case of considering the glass transition temperature (Tg) of the resin component constituting the resin particle and the wax, the temperature may be set to 5.0° C. or higher, and preferably 10.0° C. or higher, than the glass transition temperature (Tg) of the resin component constituting the resin particle.

The surface temperature of the recording medium reached by heating at the heating step is preferably 30.0° C. or higher and 120.0° C. or lower, more preferably 40.0° C. or higher and 100.0° C. or lower, still more preferably 50.0° C. or higher and 95° C. or lower, and still more preferably 70° C. or higher and 90° C. or lower. The surface temperature of the recording medium reached by heating at the heating step is particularly preferably 80° C. or higher. When the temperature of the recording medium is in such a range, the resin particle and wax contained in the recorded matter can be formed into a film and flattened, and the produced image can be dried and more sufficiently fixed.

The heating duration of the recording medium by the heating mechanism at the heating step is preferably 1 second or more and 40 seconds or less, more preferably 3 seconds or more and 25 seconds or less, and still more preferably 5 seconds or more and 20 seconds or less. The time is more preferably 9 seconds or more and 15 seconds or less. This enables formation of a sufficiently dried image at high speed.

### 1.6. Other Steps

The recording method of the present embodiment may include the following aspects and steps.

### 1.6.1. Air Blowing Step

The ink attaching step may include an air blowing step. In the ink attaching step in which the ink composition is attached to the recording medium, the surface temperature of the recording medium at that time is 27° C. or higher and 38° C. or lower. The air blowing step is performed such that the temperature is kept within the range. This enables the ink to be fixed at an early stage, and an image having better image quality can be formed.

The air blowing step can be performed by a unit that blows air at room temperature or hot air to the recording medium, such as a fan. The temperature of the air in the air blowing step is preferably adjusted so that the surface temperature of the recording medium becomes 27° C. or higher and 38° C. or lower. In particular, the temperature is preferably 40° C. or lower, more preferably 38° C. or lower, even more preferably 35° C. or lower, and still more preferably 30° C. or lower. Furthermore, the temperature is preferably 10° C. or higher, more preferably 15° C. or higher, still more preferably 20° C. or higher, and particularly preferably 25° C. or higher. The temperature may be 27° C. or higher.

The wind speed at the air blowing step is preferably 1 m/s or more and 20 m/s or less, more preferably 2 m/s or more and 15 m/s or less, and still more preferably 3 m/s or more and 13 m/s or less. Furthermore, the wind speed is more preferably 5 m/s or more and 10 m/s or less. This enables the ink to be fixed at an early stage, and an image having better image quality can be formed.

The wind speed refers to a wind speed in the vicinity of the recording medium (a separation distance between the recording medium and the head), and is a maximum wind speed in a region in which recording can be performed on the recording medium on the platen. The air temperature may be warm air, but is preferably room temperature air. The wind temperature is measured at the same position as the measurement of the wind speed without thermal effect from the platen.

### 1.7. Recording Apparatus

An example of a recording apparatus that can be used in the recording method of the present embodiment will be described. The recording apparatus according to the embodiment is a recording apparatus for performing the recording method described above and includes the processing liquid, the ink composition, a processing liquid attaching mechanism that performs the processing liquid attaching step, the ink jet head, a transport mechanism that performs the transport step, the heating mechanism, and the recording medium support.

The heating mechanism of the recording apparatus of the present embodiment has a portion positioned in a space extending from an area of the recording medium supported by the recording medium support where the ink composition is attachable toward an opposite side from the ink jet head in a vertical direction.

The following example will describe a recording apparatus that ejects and attaches the processing liquid from the ink jet head to the recording medium in the processing liquid attaching step in the same manner as the ink in the ink attaching step.

Furthermore, the recording medium support is also referred to as a platen and does not have a device for conductively heating the recording medium supported by the recording medium support. In short, the recording medium support does not have a member serving as a heat source. The term “conductively” means that heat is conducted by heat transfer without mass transfer. Furthermore, when the recording medium is “conductively” heated, the recording medium support is heated by a heat source, and heat is conducted from the recording medium support to the recording medium supported by the recording medium support, and thus the recording medium is heated. The heat source is integrally formed with the recording medium support. Thus, heat is conducted from the heat source to the recording medium support, and the heat is conducted from the recording medium support to the recording medium supported by the recording medium support. Examples of the heat source include a platen heater. The recording medium support of the present embodiment does not have such a device that conductively heats the recording medium supported by the recording medium support.

When the apparatus has a device that conductively heats the recording medium supported by the recording medium support, it is not possible to simplify the recording apparatus or to save space, for example, because a heat source is required. In particular, such a device is integrally formed with the recording medium support and tends to occupy a space below the recording medium support.

Furthermore, it is difficult for such a device to control the heating temperature of the recording medium to be appropriate. In the present embodiment, which does not have such a device, it is possible to simplify the recording apparatus and save space, and it is easy to stabilize the heating temperature of the recording medium.

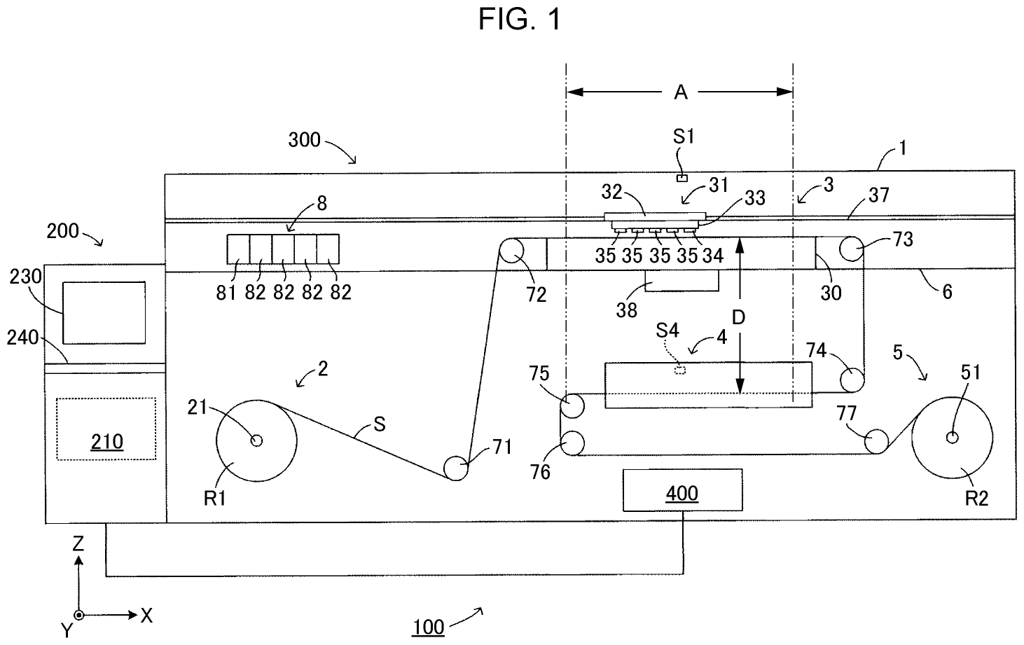

FIG. 1 is a front view schematically illustrating an example of a serial recording apparatus. In the serial type, scanning is performed in which the ink is ejected and attached from the ink jet head to the recording medium while the ink jet head and the recording medium are moved relative to each other. Thus, the ink is attached to the recording medium supported by the recording medium support, and the recording is proceeded by the scanning performed several times. For example, an ink jet head is mounted on a carriage, and the ink jet head is moved by the movement of the carriage to perform scanning.

The apparatus in FIG. 1 is a lateral recording apparatus in which the scanning direction of the carriage and the transport direction of the recording medium are the same. In other words, the scanning direction of the carriage and the transport direction of the recording medium do not cross each other. Such an apparatus is a kind of serial recording apparatus.

FIG. 1 has an XYZ orthogonal coordinate system having the Z axis as the vertical axis to clarify the positional relationship of the components of the apparatus. Furthermore, in the following description, a direction in which each coordinate axis (arrow) orients will be referred to as a positive direction, and a direction opposite the positive direction will be referred to as a negative direction as appropriate. The form of the recording apparatus illustrated in FIG. 1 is particularly referred to as a lateral recording apparatus since the recording medium is transported in the direction along the axis of the scanning direction.

The recording apparatus 100 includes a host device 200 configured to generate print data from image data (bit map data) received from an external device such as a personal computer, and a printer section 300 configured to print an image based on the print data received from the host device 200. The printer section 300 transports a long sheet S in a roll-to-roll manner and prints an image on a surface of the sheet S by using an ink jet method.

As illustrated in FIG. 1, the printer section 300 includes a body case 1 having a substantially rectangular parallelepiped shape. The body case 1 houses a feeding section 2 configured to feed the sheet S from a roll R1 formed of the wound sheet S, a printing chamber 3 configured to perform printing by ejecting ink onto the surface of the fed sheet S, a drying section 4 configured to dry the sheet S having the attached ink, and a winding section 5 configured to wind the dried sheet S into a roll R2.

More specifically, the inside of the body case 1 is vertically partitioned in a Z direction by a flat base 6 arranged parallel (that is, horizontally) to an XY plane, and the space above the base 6 is the printing chamber 3. The platen 30 is fixed to an upper surface of the base 6 at a substantially center portion in the printing chamber 3. The platen 30 has a rectangular shape and supports the sheet S from below by the upper surface parallel to the XY plane. Then, the recording unit 31 performs printing on the surface of the sheet S supported on the platen 30.

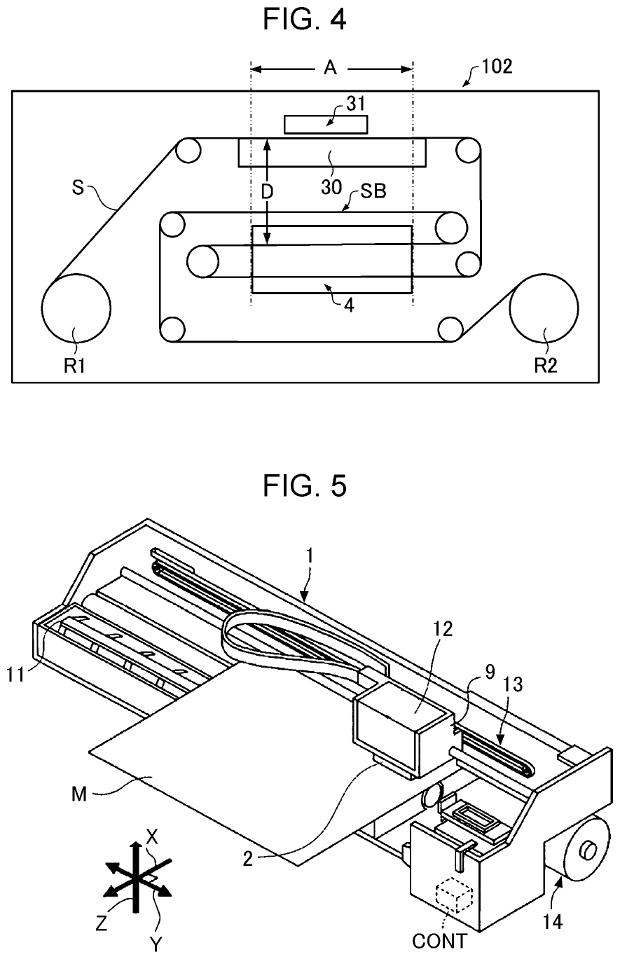

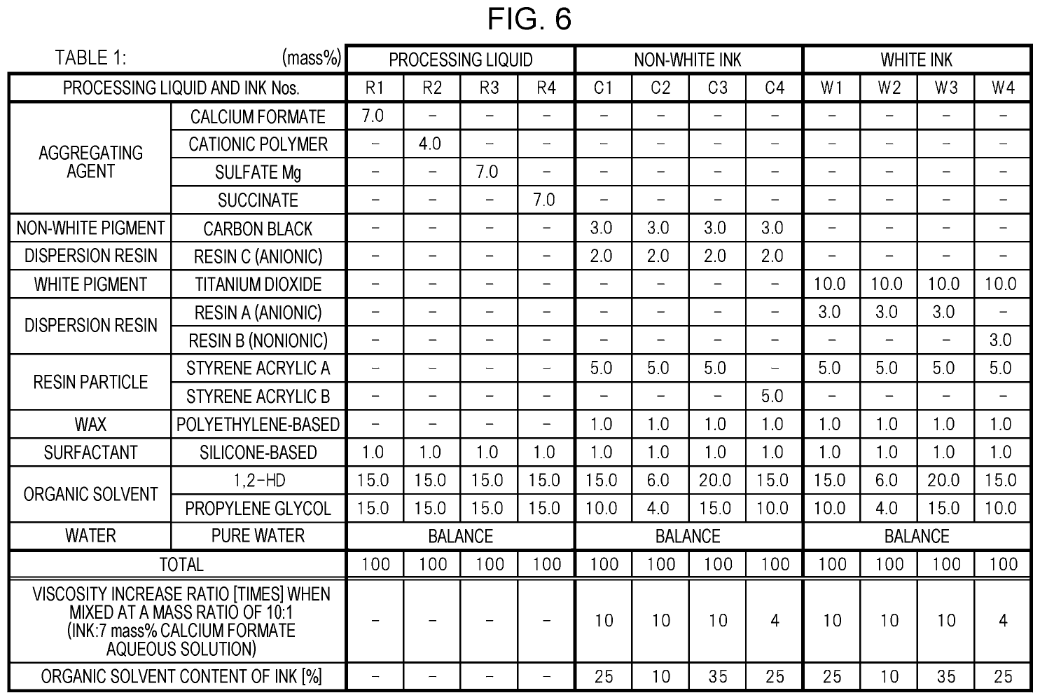

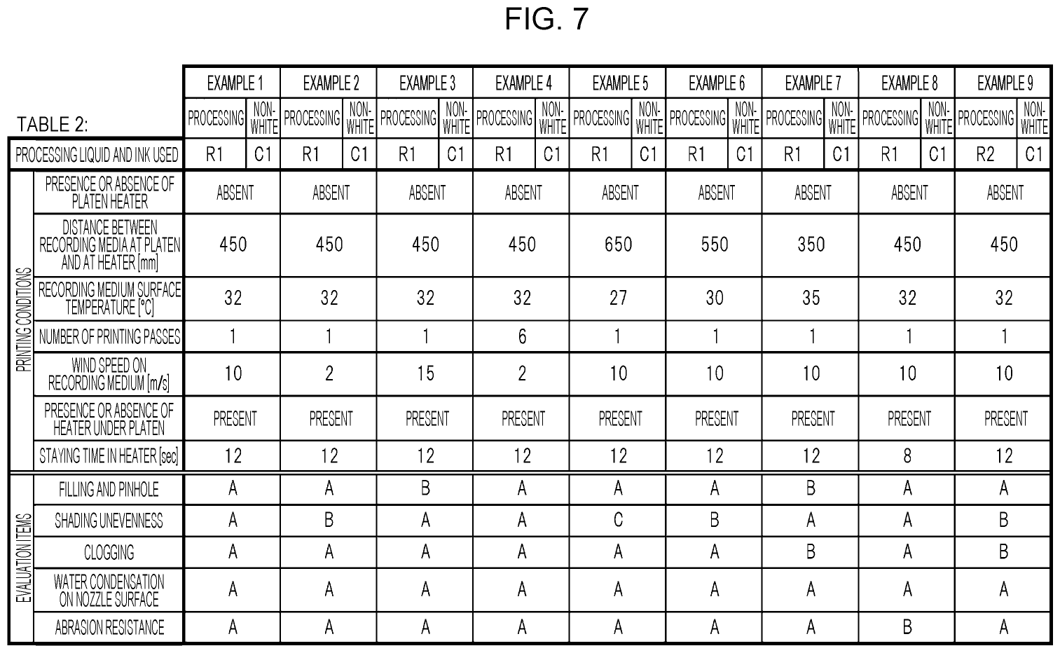

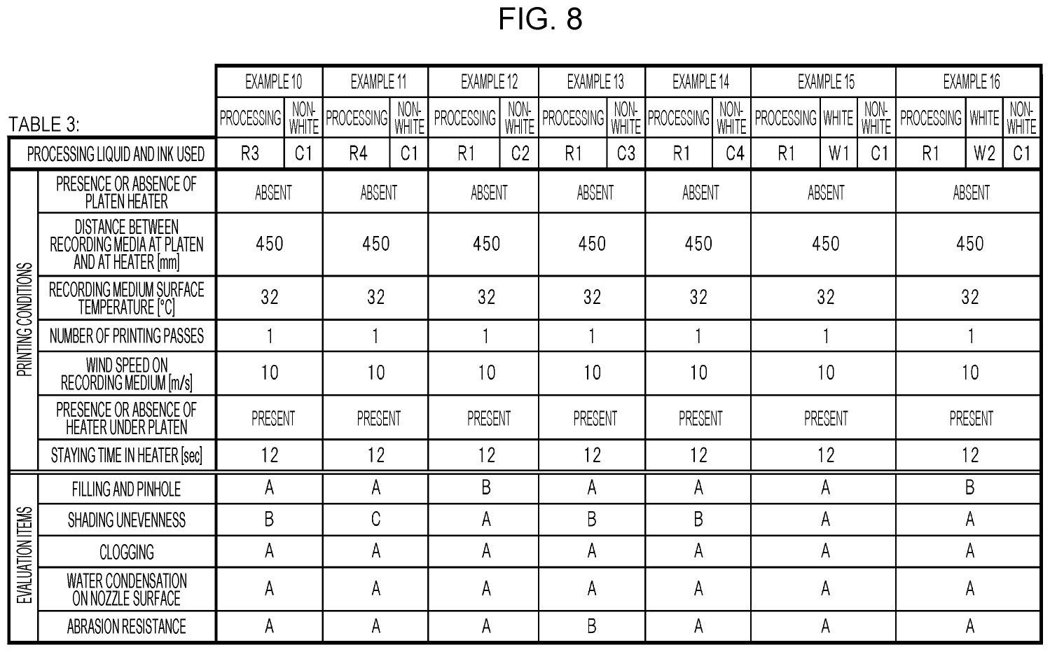

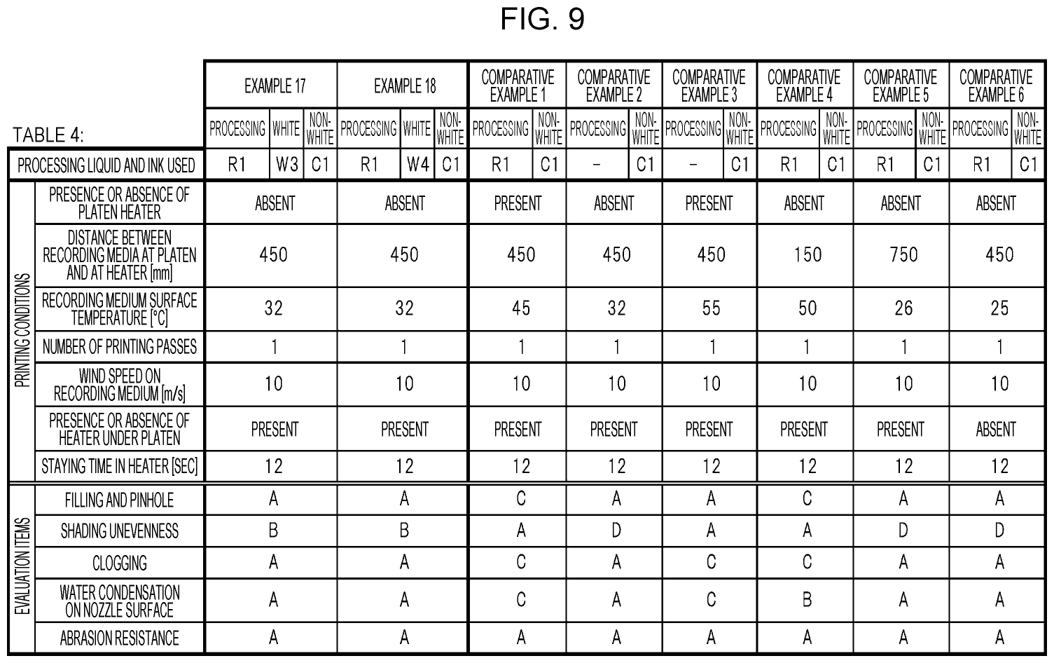

In contrast, the feeding section 2, the drying section 4, and the winding section 5 are positioned below the base 6. The feeding section 2 is positioned below and away in the negative X direction (diagonally left downward in FIG. 4) from the platen 30 and includes a rotatable feeding shaft 21. The sheet S is wound around the feeding shaft 21 and thus the roll R1 is supported. In contrast, the winding section 5 is positioned below and away in the positive X direction (diagonally right downward in FIG. 1) from the platen 30 and includes a rotatable winding shaft 51. The sheet S is wound around the winding shaft 51 and thus the roll R2 is supported. Furthermore, the drying section 4 is positioned immediately below the platen 30 and between the feeding section 2 and the winding section 5 in the X direction.

Then, the sheet S fed from the feeding shaft 21 of the feeding section 2 sequentially passes through the printing chamber 3 and the drying section 4 while being guided by rollers 71 to 77 and then is wound onto the winding shaft 51 of the winding section 5. The rollers 72 and 73 each extending in a straight line are arranged in the X direction (that is, horizontally) with the platen 30 interposed between the rollers, and the top of each of the rollers is adjusted to be positioned at the same height as the upper surface (the surface supporting the sheet S) of the platen 30. Thus, the sheet S wound on the roller 72 moves horizontally (in the X direction) to the roller 73 while being in sliding contact with the upper surface of the platen 30.

In the printing chamber 3, a recording unit 31 positioned above the platen 30 performs a printing process on a sheet S, which is a recording medium. The recording unit 31 prints an image on the surface of the sheet S by ejecting the processing liquid and the ink composition onto the surface of the sheet S. Here, the printing chamber 3 has a cartridge mounting portion 8 at an end portion (left end portion in FIG. 1) in the negative X direction, and the cartridge mounting portion 8 detachably has a processing liquid cartridge 81 configured to store the processing liquid and a plurality of ink cartridges 82 configured to store the ink compositions. The recording unit 31 can eject the processing liquid supplied from the processing liquid cartridge 81 and the ink composition supplied from the ink cartridges 82 onto the surface of the sheet S by the ink jet method.

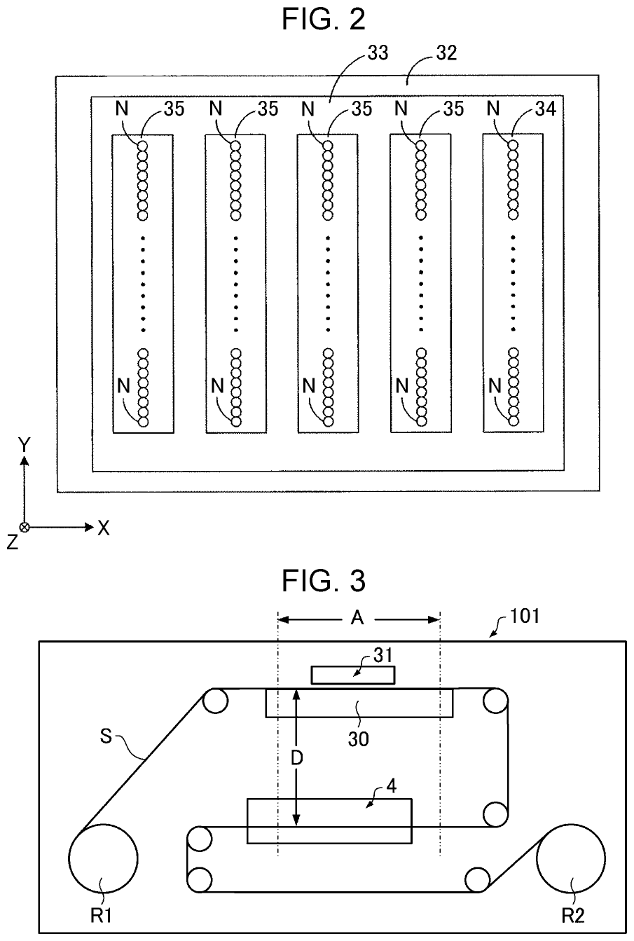

FIG. 2 is a bottom view partially illustrating the configuration of the recording unit. In this example, the recording unit 31 will be described in detail with reference to FIGS. 1 and 2. The recording unit 31 includes a carriage 32, a flat support plate 33 attached to the lower surface of the carriage 32, and an ink jet head for a processing liquid 34 and an ink jet head for ink 35, which are attached to the lower surface of the support plate 33. On the lower surface of the support plate 33, four ink jet heads for ink 35 and one ink jet head for a processing liquid 34 are arranged at equal intervals in the X direction, and in each of the ink jet heads 34 and 35, multiple nozzles N (nozzle rows) are arranged in parallel in the Y direction. The ink jet head for a processing liquid 34 ejects the processing liquid from the nozzles N, and the four ink jet heads for ink 35 eject inks of mutually different colors from the nozzles N.

In the present embodiment, the first ink composition is ejected from the ink jet head for ink 35 that is positioned adjacent to the ink jet head for a processing liquid 34, and the second ink composition is ejected from the ink jet head for ink 35 that is positioned farthest from the ink jet head for a processing liquid 34.

The nozzle rows of the ink jet head for a processing liquid 34 and the ink jet head for ink 35 preferably have a length in the Y direction equal to or greater than the length of the sheet S (recording medium) in the Y direction. When the ink jet head has such a length, recording can be performed in one pass, resulting in excellent recording speed. However, since the amount of ink attached increases, bleeding unevenness is likely to occur. In contrast, the recording apparatus of the exemplary embodiment, which uses the above-described recording method, is likely to allow the image quality (bleeding unevenness) to be excellent even when the recording is performed in one pass.

In FIG. 2, when the nozzle row for ejecting the processing liquid of the ink jet head for processing liquid 34 is projected in the head movement direction (X direction), the nozzle row for ejecting the processing liquid of the ink jet head for a processing liquid 34 has a portion overlapping the nozzle row for ejecting the ink of the ink jet head for ink 35 in the nozzle row direction (Y direction).

Such an arrangement enables the above-described recording method to perform the processing liquid attaching step and each ink attaching step by moving (scanning) the ink jet head for a processing liquid and the ink jet head for ink relative to the recording medium, allowing the processing liquid and the ink composition to be attached to the same scanning region in the same scanning (simultaneous ejection).

In FIG. 2, the number of ink jet heads is five, but the number of ink jet heads may be one or more, for example, 7 or more and 20 or less. The number of ink jet heads is equal to the number of nozzle rows. The ink jet head is a unit for ejecting one ink or a processing liquid, that is, a nozzle row. Alternatively, the number of ink jet heads may be the number of inks.

Returning to FIG. 1, the description will be continued. The carriage 32 of the recording unit 31 having the above-described configuration can move integrally with the support plate 33, the ink jet head for a processing liquid 34, and the ink jet head for ink 35. Specifically, an X-axis guide rail 37 extending in the X direction is provided in the printing chamber 3, and when the carriage 32 receives a driving force from an X-axis motor, the carriage moves along the X-axis guide rail 37 in the X direction.

The recording unit 31 ejects the processing liquid from the ink jet head for a processing liquid 34 and the ink from the ink jet head for ink 35 while moving (scanning) the carriage 32 in the X direction (main scanning direction, scanning direction) above the platen 30, so that the processing liquid and the ink composition are attached to the same scanning region in the same scanning, and thus an image is printed on the surface of the sheet S stopped on the upper surface of the platen 30. As a result, a two dimensional image corresponding to one frame is printed on the surface of the sheet S with the length of the nozzle row in the Y direction and the scanning distance in the X direction. Furthermore, the coloring material of the ink forming the two-dimensional image is aggregated by the action of the processing liquid and fixed on the surface of the sheet S.

Printing of one frame as described above is repeatedly performed while intermittently moving the sheet S in the X direction. Specifically, a predetermined region over substantially the entire upper surface of the platen 30 serves as a print area. The print area is an area of the recording medium supported by the platen to which ink can be attached during recording. In other words, the print area is an area where recording can be performed, and if there is an image to be printed in the area, ink is attached to the area.

The print area is also referred to as an attachment area A. The print area is an area of the recording medium supported by the platen, which corresponds to a region extending in the X direction and indicated by A in FIG. 1. The length of the print area in the X direction is defined as a length A. The length A is the length of the attachment area A in the recording medium transport direction and corresponds to the length in the X direction in the drawings.

The print area also has a predetermined length in the Y direction in FIG. 1. The dimension of the print area in the Y direction is a dimension in the Y direction in which ink can be attached to the recording medium supported by the platen during recording, and is, for example, a length of the nozzle row of the ink jet head in the Y direction.

Then, assuming a distance corresponding to a length in the X direction of the print area (intermittent transport distance) as a unit, the sheet S is intermittently transported in the X direction, and printing of one frame is performed on the sheet S stopped on the upper surface of the platen 30 during the intermittent transport.

In other words, when the printing of one frame ends on the sheet S stopped on the platen 30, the sheet S is transported in the X direction by the intermittent transport distance and an unprinted surface of the sheet S is stopped on the platen 30. Subsequently, the printing of one frame is newly performed on the unprinted surface. When the printing is completed, the sheet S is again transported in the X direction by the intermittent transport distance. Then, a series of these operations is repeatedly performed.

Recording of one frame on the stopped recording medium may be performed in one pass as described above, or may be performed in two or more passes. When recording is performed in two or more passes, the ink jet head may be moved in the Y direction between the passes. This is preferable, because the recording resolution in the Y direction can be increased. The number of passes is preferably 10 or less, and more preferably 6 or less. The smaller the number of passes, the faster the printing speed, which is preferable.

When the printing is performed in one pass or two or more passes, the distance of one transport may be shorter than the length A. For example, the distance of one transport may be the length A/the number of passes, and the scanning and the transport may be alternately performed.

In order to keep the sheet S stopped on the upper surface of the platen 30 flat during the intermittent transport, the platen 30 may include a mechanism for attracting the sheet S stopped on the upper surface by suction. Specifically, the platen 30 has a large number of suction holes (not illustrated) in the upper surface and a suction unit 38 attached to the lower surface. Then, when the suction unit 38 operates, a negative pressure is generated in the suction holes on the upper surface of the platen 30 and the sheet S is attracted to the upper surface of the platen 30 by suction. The suction unit 38 includes, for example, a fan (not illustrated), and generates a negative pressure in the suction holes.

While the sheet S is stopped on the platen 30 for printing, the suction unit 38 sucks the sheet S to keep the sheet S flat. On the other hand, when the printing ends, the suction unit 38 stops sucking the sheet S, allowing smooth transport of the sheet S.

In this embodiment, the platen 30 does not have a heat source, such as a heater. That is, the platen 30 does not have a device for conductively heating the recording medium supported by the platen 30. This enables simplification and space saving of the recording apparatus. Furthermore, this allows easy installation of other mechanisms such as the suction unit 38 below the platen 30.

The recording apparatus according to the embodiment may include an air blowing fan, which blows air to the recording medium from above, at a place such as the platen 30 to which the ink composition is attached. This may accelerate drying of the image, resulting in more excellent image quality. Examples of the air blowing fan include a carriage fan provided near the head and a ceiling fan that blows air from above. However, even when the recording medium includes such a fan, the surface temperature of the recording medium at the time of ink attachment is 27° C. or higher and 38° C. or lower.

Then, the sheet S on which the printing of one frame is performed moves from the platen 30 to the drying section 4 along with the intermittent transport of the sheet S. The drying section 4 can perform a post-heating step of completely drying the processing liquid and the ink composition landed on the sheet S by using air heated for drying. The drying section 4 may be a conductive type, a convection type (air blowing), or a radiation type (IR heater or the like).

In the drying section 4, the sheet S is preferably heated so that the surface temperature becomes 30.0° C. or higher and 120.0° C. or lower, preferably 40.0° C. or higher and 100.0° C. or lower, more preferably 50.0° C. or higher and 95° C. or lower, and even more preferably 70° C. or higher and 90° C. or less.

Then, the sheet S subjected to the drying process is intermittently transported to the winding section 5 and is wound into the roll R2.

Here, the drying section 4 corresponds to a heating mechanism, and the platen 30 corresponds to a recording medium support. In addition, the rollers each perform a transport step. The recording unit 31 further includes an ink jet head. The platen 30 (recording medium support) does not include a device for conductively heating the recording medium (sheet S) supported by the platen 30.

The drying section 4 (heating mechanism) is positioned in a space extending from the attachment area A (print area) of the recording medium (sheet S) supported by the platen 30 (recording medium support) where the ink composition is attachable toward an opposite side from the ink jet head (recording unit 31) in a vertical direction. In other words, the drying section 4 has a portion positioned in a space extending from the attachment area A of the recording medium supported by the platen 30 where the ink composition is attachable toward an opposite side from the ink jet head in the vertical direction. That is, at least a portion of the drying section 4 is in the space. This configuration enables the recording medium in the attachment area A to be heated by residual heat generated by the drying section 4.

The space extending in the vertical direction from the attachment area A preferably has a portion where the drying section 4 is positioned over a half or more of the dimension (the length is the length A) in the recording medium transport direction to achieve more sufficient heating, more preferably the space has a portion where the drying section 4 is positioned over 70% or more of the dimension.

The length of the drying section 4 in the recording medium transport direction (the length in the X direction in FIG. 1) is preferably equal to or greater than the length of one recording medium transport in recording. Furthermore, the length is preferably equal to or greater than half the length A of the attachment area A in the recording medium transport direction, more preferably equal to or greater than the length A of the attachment area A in the recording medium transport direction. The length of the drying section 4 is a length of a portion of the recording medium that is heated at the drying section 4.

It can be understood that even when the drying section 4 is shifted in the Y direction in the drawings from the attachment area A, the drying section 4 can have a portion positioned in a space extending from the attachment area A toward an opposite side from the ink jet head (recording unit 31) in the vertical direction.

The residual heat generated by the drying section 4 may be transmitted to the recording medium support through the air between the drying section 4 and the recording medium support. Alternatively, a member for fixing the drying section and the recording medium support may be provided between the drying section and the recording medium support, and the heat may be transmitted to the recording medium support through the member.

In the present embodiment, the recording medium support does not have a device for conductively heating the recording medium supported by the recording medium support, other than the drying section 4.

The drying section 4 is a device for heating the recording medium that is transported after the attaching step and is not originally a device for heating the recording medium supported by the recording medium support.

Since the recording medium supported by the recording medium support is heated by using the residual heat of the drying section 4, it is possible to effectively use the residual heat of the drying section 4, which is excellent in terms of energy saving and image quality.

The heating duration of the recording medium in the drying section is preferably 5 seconds or more, more preferably 8 seconds or more, and even more preferably 10 seconds or more. The duration is not particularly limited, but is preferably 20 seconds or less, more preferably 15 seconds or less, and even more preferably 13 seconds or less. This is preferable from the viewpoint of more excellent abrasion resistance, a reduction in thermal damage of the recording medium, and the like.

FIG. 3 is a front view schematically illustrating another example of the serial recording apparatus. In FIG. 3, components having the same functions as those of the recording apparatus 100 described with reference to FIG. 1 are denoted by the same reference numerals, and detailed description thereof will be omitted. In FIG. 3, only a structure for explaining the positions of members and the like is illustrated.

As illustrated in FIG. 3, the platen 30 (recording medium support) of a recording apparatus 101 also does not have a device for conductively heating the recording medium (sheet S) supported by the platen 30. The drying section 4 (heating mechanism) has a portion outside the space, which extends from the attachment area A of the recording medium (sheet S) supported by the platen 30 (recording medium support) where the ink composition is attachable toward an opposite side from the ink jet head (recording unit 31) in the vertical direction, and a portion inside the space, but has the portion positioned in the space.

FIG. 4 is a front view schematically illustrating another example of the serial recording apparatus. Also in FIG. 4, components having the same functions as those of the recording apparatus 100 described with reference to FIG. 1 are denoted by the same reference numerals, and detailed description thereof will be omitted. Also in FIG. 4, only a structure for explaining the positions of members and the like is illustrated.

As illustrated in FIG. 4, in the recording apparatus 102, the sheet S is transported to the drying section 4 (heating mechanism) and passes through two transport paths in the drying section 4. Then, the sheet S which has passed through the drying section 4 twice is transported between the platen 30 (recording medium support) and the drying section 4 (heating mechanism), passes through the transport path SB, and is wound into the roll R2. In addition, the transport path SB is not a transport path used at the transport step of transporting the recording medium to the heating mechanism after the processing liquid attaching step and the ink attaching step, but the transport path (not illustrated) used at the transport step may be provided between the platen 30 (recording medium support) and the drying section 4 (heating mechanism).

As the recording apparatus 102 of FIG. 4, when a transport path for transporting the recording medium is provided between the recording medium support and the heating mechanism, it is possible to more effectively use the heat generated by the heating mechanism and to more effectively use the space in the apparatus. Furthermore, the heating mechanism that has two layers as in the recording apparatus 102 of FIG. 4 can more sufficiently perform the secondary heating and can make the length of the recording apparatus in the horizontal direction (X direction) shorter. Furthermore, the heating mechanism may be provided in two or more layers in a space extending from an area of the recording medium supported by the recording medium support and on which the ink attaching step is performed toward an opposite side of the recording medium support from the ink jet head.

Also in the recording apparatus 102 of FIG. 4, the platen 30 (recording medium support) does not have a device for conductively heating the recording medium (sheet S) supported by the platen 30. The drying section 4 (heating mechanism) has a portion in a space extending from the attachment area A of the recording medium (sheet S) supported by the platen 30 (recording medium support) where the ink composition is attachable toward an opposite side from the ink jet head (recording unit 31) in the vertical direction.

In this way, this configuration, which includes the heating mechanism below the platen, does not include a device for conductively heating the platen, and configured to perform heating at the platen by heating the platen using residual heat of the heating mechanism, produces an image having excellent image quality. Although the temperature of the recording medium at the platen is rather low, excellent image quality can be achieved by the presence of the processing liquid, and cost reduction can also be achieved by the platen not having a heat source. In addition, this configuration is effective in saving space and saving energy and can reduce clogging of the head and the occurrence of water condensation because the temperature of the recording medium at the platen is low.

FIGS. 1, 3 and 4 indicate the shortest distance D between the recording medium which is positioned on the recording medium support and to which the ink is attached and the recording medium which is heated by the heating mechanism. The distance D indicates the shortest distance in the vertical direction (Z direction) between a recording medium in the attachment area A and a recording medium in the heating mechanism. That is, the distance D is the shortest distance between a recording medium in the attachment area A and a recording medium in the heating mechanism in the direction perpendicular to the plane of the attachment area A. When the apparatus includes multiple drying sections as in FIG. 4, the distance is the distance to one closest to the recording medium support.

The shortest distance D between the recording medium which is positioned on the recording medium support and to which ink is attached and a recording medium to which the heating step is performed at the heating mechanism is preferably 100 mm or more and 1000 mm or less, more preferably 150 mm or more and 800 mm or less, and still more preferably 200 mm or more and 700 mm or less. Furthermore, the distance D is preferably 250 mm or more and 600 mm or less, more preferably 300 mm or more and 500 mm or less, even more preferably 350 mm or more and 480 mm or less, and particularly preferably 400 mm or more and 470 mm or less.

This arrangement enables the spatial distance between the recording medium support and the heating mechanism to be more appropriate and readily reduces clogging of the nozzles of the head. Furthermore, this arrangement is preferable because this makes it easy to set the surface temperature of the recording medium in the attachment area A to be in a predetermined range.

As described above, in the recording apparatus 100, the recording apparatus 101, and the recording apparatus 102, the ink attaching step is performed on the recording medium while the recording medium is supported by the recording medium support and in a stopped state. In the case of the serial type, the head scans the recording medium stopped on the platen to attach the ink, and thus the recording medium is easily warmed on the platen even when heated at a relatively low temperature, which is preferable. In this case, the number of passes in the ink attaching step performed on the recording medium in a stopped state is preferably 6 or less, more preferably 2 or less, and even more preferably 1.

The recording apparatus which can be used in the recording method of the present embodiment may be a line recording apparatus. In the above-described examples of the recording apparatus 100, the recording apparatus 101, and the recording apparatus 102, the recording unit 31 scans relative to the recording medium in a stopped state to perform the ink attaching step. In contrast, in the case of the line recording apparatus, the recording medium is transported on the platen 30 without stopping, and the processing liquid, the ink composition, and the like are ejected from the fixed recording unit 31 during the transport to perform the ink attaching step.

Even in the case of such a line recording apparatus, the drying section 4 (heating mechanism) can be positioned in a space extending from the attachment area A of the recording medium (sheet S) supported by the platen 30 (recording medium support) where the ink composition is attachable toward an opposite side from the ink jet head (recording unit 31) in the vertical direction. In the case of a line recording apparatus, the attachment area A is defined by the positions of nozzles located upstream and downstream in the transport direction of the recording medium. For example, in FIG. 1, the recording unit 31 is fixed at the position shown in the figure, and ink is attached while the recording medium is transported in the X direction with respect to the fixed recording unit. In this case, the attachment area A is an area from the nozzle at one end in the X direction of the ink jet head to the nozzle at the other end of the ink jet head.

Even in the line type, when the recording medium passes on the platen, the recording medium can be heated.

FIG. 5 is a perspective view schematically illustrating the periphery of the ink jet head and the periphery of the recording medium support of still another example of the serial recording apparatus. Also in FIG. 5, some components such as components having the same functions as those of the recording apparatus 100 described in FIG. 1 are not illustrated. In FIG. 5, a drying section, a recording medium transport mechanism, and the like are also partially omitted.

A recording apparatus 1 includes an ink jet head 2, a carriage housing 9, a carriage body 12, a platen 11, a carriage moving mechanism 13, a transport unit 14, and a control unit CONT. The entire operation of the recording apparatus 1 is controlled by the control unit CONT.

The ink jet head 2 performs scanning in which ink is ejected from the nozzles of the ink jet head 2 while moving in the Y direction. In addition, the transport unit 14 transports the recording medium M in the X direction. The ink jet head 2 is attached to the lower surface of the carriage. In the recording apparatus, the scanning direction is a direction intersecting the transport direction.

In the example of the recording apparatus illustrated in FIG. 5, scanning and transporting are alternately performed to proceed recording. The attachment area A is an area of a portion of the recording medium M supported by the platen 11 where ink is applicable during recording and faces the ink jet head 2 during scanning of the ink jet head 2. The ink jet heads 2 may be the same as those illustrated in FIG. 2, and are arranged such that the X direction in FIG. 2 is aligned with the Y direction in FIG. 5.

Strictly speaking, facing the ink jet head 2 means facing the nozzle row of the ink jet head 2.

A drying section (not illustrated) is positioned in a space extending downward in the Z direction from the plane of the attachment area A. After the recording medium M is transported downstream in the X direction from the platen, the transport direction is changed to the downward direction in the Y direction by a roller (not illustrated), and the transport direction is further changed to the upper right direction in the drawing in the X direction below the platen in the Y direction to reach the drying section. This is the same as that in FIG. 1.

In the example of the recording apparatus of FIG. 5, the length of the attachment area A in the X direction is relatively short compared to the example of FIG. 1, but the image quality, the clogging resistance, and the like are also excellent in this example.

In the recording apparatus of the embodiment described above, the recording medium support does not include a device for conductively heating the recording medium supported by the recording medium support, and thus the ink jet head is not easily heated, clogging of the nozzles can be reduced, and the above-described recording method can be easily performed. In addition, this recording apparatus, which uses the processing liquid, allows the ink to be fixed at an early stage, enabling formation of an image having good image quality with good filling and less shading unevenness.

### 1.8. Operational Advantages

According to the recording method of the embodiment, since the recording medium support does not include a device for conductively heating the recording medium supported by the recording medium support, the ink jet head is not easily heated, and it is possible to reduce clogging of the nozzles. In addition, this recording method, which uses the processing liquid, allows the ink to be fixed at an early stage, enabling formation of an image having good image quality with good filling and less shading unevenness.

In the recording method of the present embodiment, the use of the processing liquid enables the image quality to be achieved without depending on the primary drying so much. When the temperature of the primary drying is high, there is a concern that nozzle clogging of the head or water condensation on the nozzle surface of the head may occur. However, in the recording method of the present embodiment, it is possible to avoid the temperature of the primary drying being too high. That is, in the recording method of the present embodiment, not only the processing liquid is used, but also primary drying at a moderate temperature is used in achieve excellent image quality.

### 2. EXAMPLES AND COMPARATIVE EXAMPLES

Hereinafter, the present disclosure will be specifically described with reference to Examples, but the present disclosure should not be limited to Examples. Hereinafter, “part” and “o” are based on mass unless otherwise specified. The evaluation was performed in an environment at a temperature of 25.0° C. and a relative humidity of 40.0% unless otherwise specified.

### 2.1. Preparation of Processing Liquid and Ink Composition

Processing liquid, non-white inks, and white inks according to Examples and Comparative Examples were obtained by putting ingredients according to the compositions in Table 1 into a container, mixing and stirring them for 2 hours using a magnetic stirrer, and then filtering the mixture through a membrane filter having a pore diameter of 5 μm. As the pigment, the following pigment dispersion was prepared and used.

Substances other than those described by compound names in Table 1 are as follows.
Cationic polymer: “CATIOMASTER PD-7, polyamine resin (epichlorohydrin-amine derivative resin)” manufactured by Yokkaichi Chemical Co., Ltd.
Carbon black: No. 33 (manufactured by Mitsubishi Chemical Corporation)
Dispersant resin, Resin C (anionic): acrylic acid-acrylic acid ester copolymer (weight average molecular weight: 25,000, acid value: 90)
Dispersant resin, Resin A (anionic): acrylic acid-acrylic acid ester copolymer (weight average molecular weight: 25,000, acid value: 40)
Dispersant resin, Resin B (nonionic): acrylic acid-acrylic acid ester copolymer (weight average molecular weight: 25,000, acid value: 0)
Resin particles, styrene-acrylic A: see below (high aggregability)
Resin particles, styrene-acrylic B: see below (low aggregability)
Wax, polyethylene-based: “Nopcoat PEM-17” (trade name, manufactured by San Nopco)
Surfactant: silicone-based surfactant “BYK348” manufactured by BYK
1,2-HD: 1,2-hexanediol
Resin particles: Preparation of Styrene-Acrylic B

A resin emulsion B (acid value: 7 mg KOH/g) was obtained by emulsion copolymerization of 75 parts by mass of styrene, 0.8 parts by mass of acrylic acid, 14.2 parts by mass of methyl methacrylate, and 10 parts by mass of cyclohexylmethacrylate. As a surfactant for emulsion polymerization, Newcol NT-30 (manufactured by Nippon Nyukazai Co., Ltd.) was used, and the used amount was 2 parts by mass based on 100 parts by mass of the total amount of monomers.
Resin particles: Preparation of Styrene-Acrylic A

A resin emulsion A (acid value: 30 mg KOH/g) was obtained in the same manner as described above except that the monomer composition was changed. The amount of the surfactant for emulsion polymerization was 1 part by mass based on 100 parts by mass of the total amount of the monomers.

### Preparation of Pigment Dispersion Liquid

### White Pigment Dispersion Liquid Using Resin A

First, 12 parts by mass of the resin A as a resin dispersant was added to and dissolved in 155 parts by mass of ion-exchanged water in which 0.1 parts by mass of a 30% aqueous ammonia solution (neutralizing agent) was dissolved. To this product, 40 parts by mass of titanium dioxide (C.I. Pigment White 6), which was a white pigment, was added and dispersed in a ball mill using zirconia beads for 10 hours. Then, impurities such as coarse particles and dust were removed by centrifugal filtration using a centrifuge, and the concentration of the white pigment was adjusted to 20% by mass, and thus a white coloring material dispersion liquid was produced. As for the particle diameter of the white pigment, an average particle diameter was 350 nm.

### White Pigment Dispersion Liquid Using Resin B

A white coloring material dispersion liquid was produced in the same way except that the resin B was used as the resin dispersant. As for the particle diameter of the white pigment, an average particle diameter was 350 nm.

### Non-White Pigment Dispersion Liquid Using Resin C

A non-white coloring material dispersion liquid (black) was produced in the same way except that the resin C was used as the resin dispersant, carbon black was used as the coloring material, and the resin dispersant was added in an amount such that the mass ratio of the resin dispersant to the pigment was as indicated in Table 1. As for the particle diameter of the pigment, the average particle diameter was 60 nm.

### 2.2. Evaluation Method

### 2.2.1. Viscosity Increase Ratio

In Table 1, “viscosity increase ratio (times) when mixed at mass ratio of 10:1 (ink: 7% by mass aqueous calcium formate solution)” is measured using a rheometer MCR302, manufactured by Anton Paar under conditions of 25° C. and shear rate of 200s⁻¹ after each ink and 7% by mass aqueous calcium formate solution are mixed at a mass ratio of 10:1 and stirred for 1 minute and is the ratio of the viscosity of the liquid mixture after mixing to the viscosity of the ink before mixing. When the viscosity of the liquid mixture was measured, the sample was taken from the well-stirred liquid mixture.

### 2.2.2. Recording Test

The ink and the processing liquid were filled in a modified machine of a digital label printer SurePress L-4733A, and the components were positioned as illustrated in FIG. 1. The apparatus was a serial recording apparatus.

The surface temperature of the recording medium in the drying section 4 (heating mechanism) was set to 75° C. As the recording medium, PET50A (manufactured by Lintec Corporation) was used.

The nozzle density of the recording head was set to 1200 dpi, and the number of droplets for each pixel was adjusted so that the attachment amounts became the values in the following tests based on the recording resolutions 1200×1200 dpi. The mass of the droplet of the processing liquid was 3 ng, and the mass of the droplet of the ink was 7 ng.

Air was blown from above the platen toward the recording medium by an air blowing mechanism. The air was blown at an air temperature of 25° C. and at wind speeds indicated in tables.

The heating durations of a certain portion of the recording medium in the drying section (staying time) are indicated in the tables.

In tables, an example in which the space extending downward in the vertical direction from the attachment area A has a portion where the drying section is positioned is indicated as the heater is present under platen. In examples without the drying section under the platen, the drying section was provided at a position completely shifted to the right in the X direction from the space extending downward in the vertical direction from the attachment area A.

The distance between the recording medium in the attachment area A and the recording medium in the drying section in the Y direction is indicated in the tables. In some examples, this distance was varied.

Examples in which the platen does not have a heater are examples that do not have a device for conductively heating the recording medium supported by the platen, and are indicated as “absent” in the tables.

Tables indicate the number of printing passes. In each of the examples, the distance of one transport corresponds to the length A in the X direction. In the example of two passes, the recording medium was not transported while two passes were performed, and the recording medium was transported after two passes. The attachment amount of the ink or the like was the same as in the example of one pass, and half of the attachment amount was attached in each of the passes. The same applies to an example of more than two passes.

The number of passes is the number of passes per one ink, and the processing liquid was also attached in an overlapping manner in the same pass as the pass of the ink. In examples in which the white ink is used, the white ink was first attached in the number of passes indicated in the tables, and then the non-white ink was attached in an overlapping manner in the number of passes indicated in the tables. Half of the processing liquid was attached in an overlapping manner in the same pass as the white ink, and the remaining amount of the processing liquid was attached in an overlapping manner in the same pass as the non-white ink. During this, the recording medium is not transported.

### 2.2.3. Evaluation of Filling and Pinhole of Image

In the example using the processing liquid and the non-white ink, the ejection amount was as follows: processing liquid: 1.5 mg/inch²; and non-white ink: 7.0 mg/inch².

In the example using the processing liquid, the white ink, and the non-white ink, the ejection amount was as follows:
processing liquid: 1.5 mg/inch²;
white ink: 7.0 mg/inch²; and
non-white ink: 3.0 mg/inch².

The solid image region of the produced recorded matter was visually observed under a fluorescent lamp and evaluated according to the following criteria, and the results are shown in Tables 2 to 4.
A: No unfilled areas or pinholes are found
B: Unfilled areas and pinholes are slightly visible
C: Unfilled portions and pinholes are remarkably visible

### 2.2.4. Evaluation of Shading Unevenness in Image

In the example using the processing liquid and the non-white ink, the ejection amount was as follows:
processing liquid: 1.5 mg/inch²; and
non-white ink: 9.0 mg/inch².

In the example using the processing liquid, the white ink, and the non-white ink, the ejection amount was as follows:
processing liquid: 1.5 mg/inch²;
white ink: 9.0 mg/inch²; and
non-white ink: 5.0 mg/inch².

The solid image region of the produced recorded matter was visually observed under a fluorescent lamp and evaluated according to the following criteria, and the results are shown in Tables 2 to 4.
A: No shading unevenness was found
B: Shading unevenness was slightly visible
C: Shading unevenness was remarkably visible
D: Shading unevenness was remarkably visible, and ink at the outline of pattern was blurred and was not linear

### 2.2.5. Evaluation of Clogging

After continuous printing was performed for 1 hour under the conditions of the recording test, suction cleaning was performed to recover the non-ejecting nozzles, and nozzle was inspected. In one cleaning, 1 cc of ink was discharged from the nozzle row. Evaluation was performed according to the following criteria, and the results are indicated in Tables 2 to 4.
A: All nozzles were recovered within one cleaning
B: All nozzles were recovered within three times of cleaning
C: Not all nozzles were recovered within four times of cleaning

### 2.2.6. Evaluation of Water Condensation on Nozzle Surface

For each ink nozzle row, image recording was continuously performed for one hour under the conditions indicated in the table, and this was performed three times (total 3 hours). The nozzles of the ejection nozzle group after the recording were inspected, and the nozzle surfaces were observed. A case where non-ejection or flight deflection of equal to or more than half of the distance between adjacent nozzles occurred was regarded as ejection failure. It was evaluated whether or not flight deflection or the like was caused by contact of the ink with the water condensation. Evaluation was performed according to the following criteria, and the results are indicated in Tables 2 to 4.
A: The nozzle surface had no water condensation. No nozzles had ejection failure.
B: The nozzle surface had slight water condensation. 3% or less of nozzles had ejection failure.
C: The nozzle surface had considerable water condensation.

More than 3% of nozzles had ejection failure.

### 2.2.7. Evaluation of Abrasion Resistance

A recorded matter under the same conditions as that was used in the evaluation of shading unevenness was used. The recorded portion was rubbed 50 times with a plain weave cloth wetted with water by using a Gakushin-type rubbing resistance tester (load 500 g), and the degree of peeling of the ink was visually observed. Evaluation was performed according to the following criteria, and the results are indicated in Tables 2 to 4.
A: Peeling was observed in 10% or less of the evaluation area.
B: Peeling was observed in more than 10% of the evaluation area.

### 2.3. Evaluation Results

Referring to Tables 2 to 4, it was found that all the examples in which the ink composition is an aqueous ink composition containing a coloring material, the ink attaching step is performed on the recording medium supported by the recording medium support, the recording medium support does not have a device for conductively heating the recording medium, the heating mechanism has a portion positioned in the space extending from the area of the recording medium supported by the recording medium support where the ink composition is attachable toward an opposite side from the ink jet head in the vertical direction, and the surface temperature of the recording medium subjected to the ink attaching step while supported by the recording medium support is 27° C. or higher and 38° C. or lower had results of high image quality (filling and pinhole, shading unevenness) and less clogging.

Although not indicated in the table, when the recording apparatus in FIG. 1 was modified to a line recording apparatus as described above and then recording was performed in the same manner as in Examples, the evaluation results were also excellent. Furthermore, when the recording apparatus in FIG. 1 was modified to a recording apparatus in which heating was performed twice in the drying section as in FIG. 4, the abrasion resistance showed a tendency to be better.

The present disclosure embraces configurations substantially identical to those described in the embodiments, such as configurations identical in function, methodology, and results or having the same goal and offering the same advantages as the described ones. The present disclosure also includes configurations created by changing any nonessential part of those described in the above embodiments. Furthermore, the present disclosure encompasses configurations identical in operation and effect to or capable of fulfilling the same purposes as those described in the above embodiments. Configurations obtained by adding any known technology to those described in the embodiments are also included in the present disclosure.

The followings are derived from the above-described embodiments and modification examples.

The recording method includes attaching a processing liquid containing an aggregating agent to a recording medium; ejecting and attaching an ink composition from an ink jet head to the recording medium; transporting the recording medium after the attaching the processing liquid and the attaching the ink composition to a heating mechanism; and heating the transported recording medium at the heating mechanism, wherein the ink composition is an aqueous ink composition containing a coloring material, the ink composition is attached to the recording medium while the recording medium is supported by a recording medium support, the recording medium support is free of a device that conductively heats the recording medium supported by the recording medium support, the heating mechanism has a portion positioned in a space extending from an area of the recording medium supported by the recording medium support where the ink composition is attachable toward an opposite side from the ink jet head in a vertical direction, and the recording medium supported by the recording medium support and to which the ink composition is attached has a surface temperature of 27° C. or higher and 38° C. or lower.

According to the recording method, the recording medium support does not include a device for conductively heating the recording medium supported by the recording medium support, and thus the ink jet head is unlikely to be heated, resulting in reduction in clogging of the nozzles. In addition, this recording method, which uses the processing liquid, allows the ink to be fixed at an early stage, enabling formation of an image having good image quality with good filling and less shading unevenness.

In the above-described recording method, a shortest distance between the recording medium positioned on the recording medium support and to which the ink composition is attached and the recording medium to which the heating is performed by the heating mechanism may be 200 mm or more and 700 mm or less.

According to this recording method, the spatial distance between the recording medium support and the heating mechanism is more appropriate, resulting in further reduction in clogging of the nozzles.

In the recording method, the attaching the ink composition may include blowing air.

This recording method enables the ink to be fixed at an early stage, and an image having better image quality can be produced.

In the recording method, the blowing may have a wind speed of 2 m/s or more and 15 m/s or less.

This recording method enables the ink to be fixed at an early stage, and an image having better image quality can be produced.

In the recording method, the ink composition may be attached to the recording medium while the recording medium is supported by the recording medium support and in a stopped state.

In the recording method, the number of passes in the attaching the ink composition may be 6 or less.

In the recording method, the aggregating agent may be selected from polyvalent metal salts.

This recording method can form an image having better image quality.

In the recording method, the ink composition may have a viscosity increase ratio of 5 times or more when mixed with an aqueous calcium formate solution such that a mass ratio of the ink composition to the aqueous solution is 10:1.

This recording method can form an image having better image quality.

In the recording method, the ink composition may include a non-white ink containing a non-white coloring material and a white ink containing a white coloring material.

In the recording method, the recording medium may be heated by the heating mechanism for 3 seconds or more and 25 seconds or less.

According to this recording method, a sufficiently dried image can be formed at a high speed.

In the recording method, a transport path for transporting the recording medium may be provided between the recording medium support and the heating mechanism.

According to this recording method, the heat generated by the heating mechanism can be more effectively used.

In the recording method, the ink composition may contain an organic solvent in an amount of 108 by mass or more and 35% by mass or less.

A recording apparatus is an apparatus for performing any one of the above-described recording methods, and the apparatus includes the processing liquid; the ink composition; a processing liquid attaching mechanism that performs the attaching the processing liquid; the ink jet head; a transport mechanism that performs the transporting; the heating mechanism; and the recording medium support.

According to the recording apparatus, the recording medium support does not include a device for conductively heating the recording medium supported by the recording medium support, and thus the ink jet head is not easily heated, resulting in reduction in clogging of the nozzles. In addition, this recording apparatus, which uses the processing liquid, allows the ink to be fixed at an early stage, enabling formation of an image having good image quality with good filling and less shading unevenness.

What is claimed is:

1. A recording method comprising:
attaching a processing liquid containing an aggregating agent to a recording medium;
ejecting and attaching an ink composition from an ink jet head to the recording medium;
transporting the recording medium after the attaching the processing liquid and the attaching the ink composition to a heating mechanism; and
heating the transported recording medium at the heating mechanism, wherein
the ink composition is an aqueous ink composition containing a coloring material,
the ink composition is attached to the recording medium while the recording medium is supported by a recording medium support,
the recording medium support is free of a device that conductively heats the recording medium supported by the recording medium support,
the heating mechanism has a portion positioned in a space extending from an area of the recording medium supported by the recording medium support where the ink composition is attachable toward an opposite side from the ink jet head in a vertical direction, and
the recording medium supported by the recording medium support and to which the ink composition is attached has a surface temperature of 27° C. or higher and 38° C. or lower.

2. The recording method according to claim 1, wherein
a shortest distance between the recording medium positioned on the recording medium support and to which the ink composition is attached and the recording medium to which the heating is performed by the heating mechanism is 200 mm or more and 700 mm or less.

3. The recording method according to claim 1, wherein
the attaching the ink composition includes blowing air.

4. The recording method according to claim 2, wherein
the blowing has a wind speed of 2 m/s or more and 15 m/s or less.

5. The recording method according to claim 1, wherein
the ink composition is attached to the recording medium while the recording medium is supported by the recording medium support and in a stopped state.

6. The recording method according to claim 1, wherein
the number of passes in the attaching the ink composition is 6 or less.

7. The recording method according to claim 1, wherein
the aggregating agent is selected from polyvalent metal salts.

8. The recording method according to claim 1, wherein
the ink composition has a viscosity increase ratio of 5 times or more when mixed with an aqueous calcium formate solution such that a mass ratio of the ink composition to the aqueous solution is 10:1.

9. The recording method according to claim 1, wherein
the ink composition includes a non-white ink containing a non-white coloring material and a white ink containing a white coloring material.

10. The recording method according to claim 1, wherein
the recording medium is heated by the heating mechanism for 3 seconds or more and 25 seconds or less.

11. The recording method according to claim 1, wherein
a transport path for transporting the recording medium is provided between the recording medium support and the heating mechanism.

12. The recording method according to claim 1, wherein
the ink composition contains an organic solvent in an amount of 10% by mass or more and 35% by mass or less.

13. A recording apparatus for performing the recording method according to claim 1, the apparatus comprising:
the processing liquid;
the ink composition;
a processing liquid attaching mechanism that performs the attaching the processing liquid;
the ink jet head;
a transport mechanism that performs the transporting;
the heating mechanism; and
the recording medium support.
